(19) United States
(12) Patent Application Publication
(10) Pub. No.: US 2016/0026341 A1
(43) Pub. Date: Jan. 28, 2016

(54) MATRIX INTERFACE FOR ENABLING ACCESS TO DIGITAL CONTENT

(71) Applicant: Igor Kraev, San Jose, CA (US)

(72) Inventor: Igor Kraev, San Jose, CA (US)

(21) Appl. No.: 14/338,271

(22) Filed: Jul. 22, 2014

(51) Int. Cl. G06F 3/0482; G06F 3/0481

(52) U.S. Cl. CPC G06F 3/0482; G06F 3/04817

(57) ABSTRACT

A system, method, and computer program product are provided for implementing a matrix interface for enabling access to digital content. The method includes the steps of receiving instructions for generating a matrix interface that enables a user to select digital content to be processed by a device and executing the instructions to cause the matrix interface to be presented on a display associated with the device. The matrix interface comprises a plurality of icons arranged in a two-dimensional array, each icon in the plurality of icons being associated with a portion of the digital content.

### FIELD OF THE INVENTION

The present invention relates to computer interfaces, and more particularly to a matrix interface for enabling access to a digital content.

### BACKGROUND

Streaming multimedia content across the Internet has become big business for companies like Netflix®, Spotify®, Pandora®, and the like. The increased bandwidth provided by Digital Subscriber Lines (DSL) and Fiber Optic Cable enables enriched content such as streaming audio and video to be downloaded and consumed in real-time. Such services are commonly streamed to desktop and laptop computers, set-top boxes, tablets, and mobile devices. Consumers can now stream and listen to a radio station or playlist and watch television programs or movies at the touch of a button.

As mentioned above, these services are typically provided on a variety of platforms. A different interface is typically designed for each platform. For example, a particular service may have a first interface for a desktop or laptop computer, a second interface for a set-top box or smart television, and a third interface for a tablet or mobile phone. Each interface is designed for the particular platform that the interface is displayed on and may provide a different feel or look of the service depending on the platform. Thus, the same service may have three or more different interfaces for different devices that the consumer may use to access content from the service. Learning to use different interfaces may be difficult for the consumer and may detract from the overall customer experience with the service. Thus, there is a need for addressing this issue and/or other issues associated with the prior art.

### SUMMARY

A system, method, and computer program product are provided for implementing a matrix interface for enabling access to digital content. The method includes the steps of receiving instructions for generating a matrix interface that enables a user to select digital content to be processed by a device and executing the instructions to cause the matrix interface to be presented on a display associated with the device. The matrix interface comprises a plurality of icons arranged in a two-dimensional array, each icon in the plurality of icons being associated with a portion of the digital content.

### BRIEF DESCRIPTION OF THE DRAWINGS

FIG. 1A illustrates a flowchart of a method for presenting a matrix interface on a device, in accordance with one embodiment;

FIG. 1B illustrates a simple matrix interface, in accordance with one embodiment;

FIG. 2A illustrates a matrix interface, in accordance with one embodiment;

FIG. 2B illustrates the control icons of the interface of FIG. 2A, in accordance with one embodiment;

FIGS. 3A through 3C illustrate the interface displayed on multiple platforms, in accordance with one embodiment;

FIGS. 4A through 4E illustrate a hierarchical matrix interface, in accordance with another embodiment;

FIGS. 5A through 5C illustrate various implementations of the matrix interface for different types of digital content, in accordance with various embodiments;

FIG. 6A illustrates the functionality associated with a set of control icons in an interface, in accordance with another embodiment;

FIG. 6B illustrates the functionality associated with a set of control icons in an interface, in accordance with yet another embodiment;

FIG. 7 illustrates a network environment having a plurality of devices, in accordance with one embodiment;

FIG. 8 illustrates a flowchart of a method for presenting a matrix interface on a device, in accordance with another embodiment; and

FIG. 9 illustrates an exemplary system in which the various architecture and/or functionality of the various previous embodiments may be implemented.

### DETAILED DESCRIPTION

A graphical user interface (GUI) is disclosed that conforms to a consistent appearance across a variety of different platforms. The different platforms may comprise different operating system environments, different processors and/or architectures, and the like. For example, the same interface may be used for a desktop environment running a Microsoft® Windows operating system, a set-top box environment running a Linux operating system, a tablet running an Apple® iOS operating system, and a mobile device running a Google® Android operating system. In some embodiments, the interface may be designed using a device-independent programming language and then ported to a source code and compiled for the various platforms without changing the source code for the interface. In other embodiments, the interface may be programmed in different programming languages corresponding to the different applications of the different platforms in such a manner that the appearance of the interface appears substantially the same to a user of the different devices having different platforms. The interface enables a user to access digital content stored on a device or streamed from an online service to be played from any device with a consistent user experience.

As further described below, the GUI disclosed herein has some advantages over existing interfaces. User's may select content associated with two important features with a single click, allowing for easy filtering of large sets of content without the addition of extra clicks. A single presentation on a display device may include 10s or even hundreds of links to content, making the accessibility of content convenient and clearly structured. Most content may be reached within a minimum number of hierarchical menu levels (e.g., 1, 2, or 3 levels). Scalability of the GUI allows for the interface to be portable to multiple devices even with vastly differing screen resolution and sizes. The scalability also enables accessibility functionality to be built into the interface, allowing labels to be scaled to enable better readability for people with poor vision. Finally, although many interfaces are designed for either touch input or mouse input, the interface disclosed herein may be easily utilized with both types of input. Furthermore, the interface is easily designed to use voice control input to, for example, enable hands free selection of content in a vehicle entertainment system.

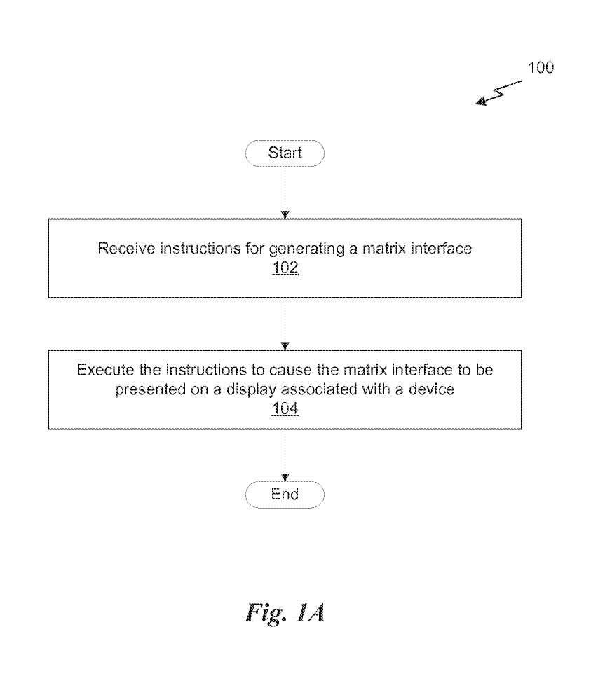

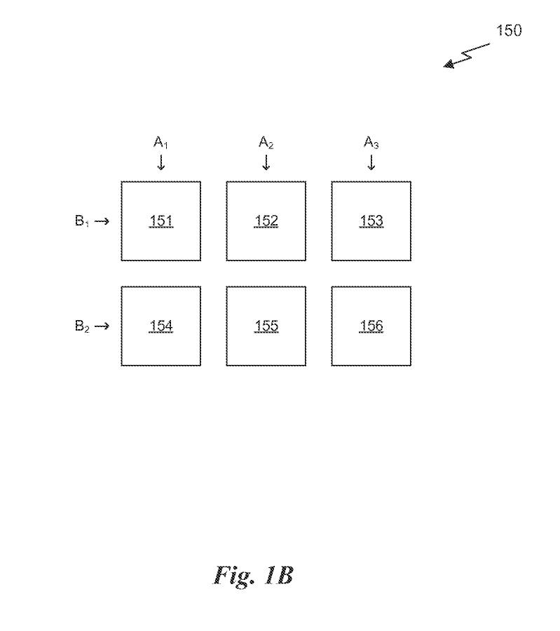

FIG. 1A illustrates a flowchart of a method 100 for presenting a matrix interface on a device, in accordance with one embodiment. Although the method 100 is described in the context of a program executed by a processor, the method 100 may also be performed by custom circuitry or by a combination of custom circuitry and a program. At step 102, instructions for generating a matrix interface are received. The instructions may be received by reading the instructions from a memory or receiving the instructions at an interface such as a network interface. The matrix interface enables a user to select digital content to be processed by a device. In some embodiments, the digital content may include digital video content; digital audio content; digital image content such as a slideshow of one or more images; digital text content such as a newsfeed, RSS feed or the like; application content such as flash-based applications, javascript-based applications, or the like; or any other type of digital content. Based on the selection of the digital content using the matrix interface, the device may be configured to process the content by displaying the content, outputting the content to an auxiliary device, and/or executing the content.

At step 104, the instructions are executed to cause the matrix interface to be presented on a display associated with the device. Presenting the matrix interface on the display of the device comprises updating the display with image content that includes a graphical representation of the matrix interface. In one embodiment, the matrix interface comprises a plurality of icons arranged in a two-dimensional array; each icon in the plurality of icons being associated with a portion of the digital content.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 1B illustrates a simple matrix interface 150, in accordance with one embodiment. As shown in FIG. 1B, the interface 150 includes a plurality of icons (e.g., 151, 152, etc.) arranged in a two-dimensional array. The interface 150 includes a first row of icons (i.e., icon 151, icon 152, and icon 153) as well as a second row of icons (i.e., icon 154, icon 155, and icon 156). The interface 150 also includes a first column of icons (i.e., icon 151 and icon 154), a second column of icons (i.e., icon 152 and icon 155), and a third column of icons (i.e., icon 153 and icon 156).

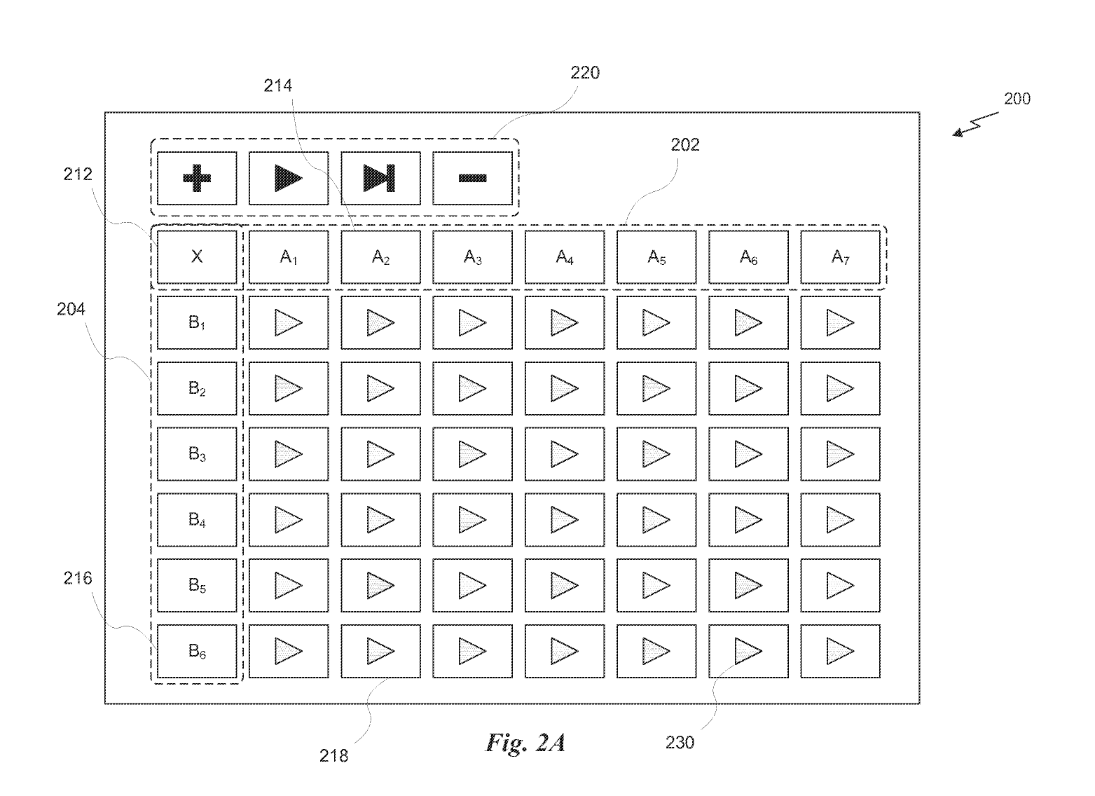

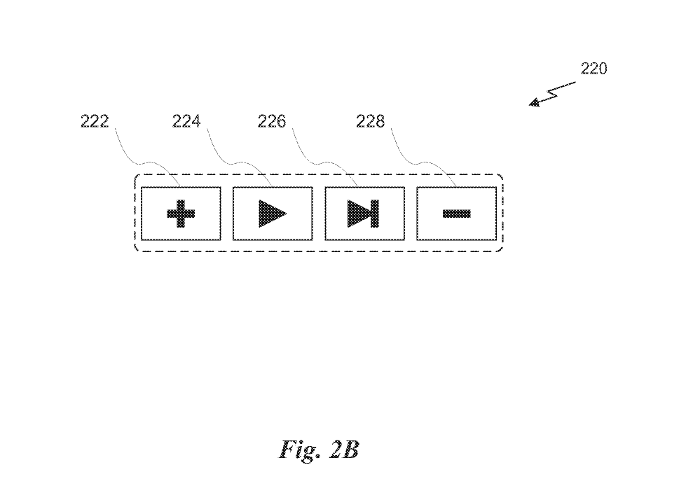

Each icon in the interface 150 enables a user to select items of content from a library of digital content (e.g., a playlist, set of streaming channels, etc.) with a single input (e.g., a mouse click, touch input, or voice control input, etc.). Each column of icons in the interface 150 is associated with a first set of tags, set Aᵢ, and each row of the interface 150 is associated with a second set of tags, set Bᵢ. Each set of tags may include one or more tags that describe the items in the library of digital content. The tags may be metadata included in the data structure for each of the items. Examples of the types of tags that may be associated with the matrix interface are set forth below in conjunction with FIGS. 2A-5C.

By selecting an icon in a particular column and a particular row of the interface 150, a user may select items of digital content associated with at least one tag in the first set of tags Aᵢ associated with that particular column and at least one tag in the second set of tags Bᵢ associated with that particular row. For example, as shown in FIG. 1B, icon 151 may be used to select items of digital content associated with at least one tag in a first set of tags A₁ and at least one tag in a second set of tags B₁; icon 152 may be used to select items of digital content associated with at least one tag in a first set of tags A₂ and at least one to in a second set of tags B₁; icon 153 may be used to select items of digital content associated with at least one tag in a first set of tags A₃ and at least one tag in a second set of tags B₁; icon 154 may be used to select items of digital content associated with at least one tag in a first set of tags A₁ and at least one tag in a second set of tags B₂; icon 155 may be used to select items of digital content associated with at least one tag in a first set of tags A₂ and at least one tag in a second set of tags B₂; and icon 156 may be used to select items of digital content associated with at least one tag in a first set of tags A₃ and at least one tag in a second set of tags B₂.

In yet another embodiment, the interface 150 may enable a user to contemporaneously select two or more icons to select content associated with a subset of icons of the interface 150. For example, selecting both icon 153 and icon 155 enables the user to select items of digital content associated with at least one tag in a first set of tags A₃ and at least one tag in a second set of tags B₁ (i.e., items of digital content associated with icon 153) as well as additional items of digital content associated with at least one tag in a third set of tags A₂ and at least one tag in a fourth set of tags B₂ (i.e., items of digital content associated with icon 155). Such functionality enables a user to easily select various combinations of subsets of the content in the library of digital content.

The interface 150 is the simplest form of the matrix interface and must include at least two icons in one or more rows and one or more columns. The matrix interface may also be extended with additional functionality and additional user interface elements as described in more detail below.

FIG. 2A illustrates a matrix interface 200, in accordance with one embodiment. As shown in FIG. 2A, the interface 200 is a graphical user interface (GUI) that may be presented on a display device of a variety of devices. The types of devices that may implement the interface 200 include desktop computers, laptop computers, tablets, mobile devices (e.g., cellular phones, PDAs, iPad Touch, etc.), set-top boxes/televisions, cameras, and other personal consumer electronics. In some embodiments, the interface 200 may be implemented within vehicle entertainment systems such as in automobiles, planes, trains, and the like. The interface 200 includes a plurality of icons (e.g., icons 212, 214, 216, 218, etc.) arranged in a matrix (i.e., a two dimensional array), each icon in the plurality of icons being associated with at least a portion of a library of digital content associated with the interface 200. In some embodiments, the matrix may be a 1×N matrix (i.e., a single row of two or more icons) or an N×1 matrix (i.e., a single column of two or more icons). In other embodiments, the matrix includes two or more rows of icons and two or more columns of icons.

In one embodiment, the interface 200 includes a first row of icons 202, each icon in the first row of icons 202 is associated with one or more tags that describe digital content included in a library of digital content. As used herein, digital content may include audio data, image data, video data (with or without embedded audio), text data, markup data such as HTML or XML, applications, and the like. As also used herein, tags refer to metadata that describes the digital content, which may take the form of a non-hierarchical keyword or term. For example, metadata may include a genre associated with an audio file, an artist associated with the audio file, a date or year associated with the audio file, and so forth. The tags are not limited to text-based terms and, in some embodiments, may take the form of text, pointers (i.e., references to additional data), images, bookmarks, and the like. Each icon in the first row of icons 202 is located at the top of a column of icons representing different portions of the digital content that corresponds with the tags associated with the icon located at the top of the column of icons.

For example, as shown in FIG. 2A, the first row of icons 202 includes eight icons. Each of the eight icons may be associated with a set of tags that includes one or more tags. In one embodiment, the first icon, icon 212, in the first row of icons 202 is associated with a set of tags, X. The set X includes all such tags related to the library of digital content. Therefore, a user may select the icon 212 in order to process all digital content included in the library of digital content associated with the interface 200. For example, if the library of digital content comprises audio files, then the icon 212 may be selected to play all of the audio files in, e.g., a set order in a playlist or in a random order. In another embodiment, the icon 212 may not be associated with any tags and, for example, may be left blank and have no functionality for selecting items from the library of digital content. Instead, the icon 212 may be a placeholder for functionality of hierarchical matrix interfaces, as described in more detail below.

Each of the other icons in the first row of icons 202 may be associated with different sets of tags, Aᵢ. Each set Aᵢ may represent a subset of tags included in set X. For example, if the library of digital content comprises audio files, then each set Aᵢ may represent tags associated with different genres of music. Set A₁ may include all tags related to “Pop” music; set A₂ may include all tags related to “Country” music; and so forth.

The device may be configured to process a subset of digital content from the library in response to one of the icons in the first row of icons 202 being selected by a user. Again, in the example where the library of digital content comprises audio files, the subset of audio files associated with each icon comprises all of the audio files in the library that are associated with a tag included in the set corresponding to that icon. In the audio library example, where icon 214 is associated with a set of tags related to “Country” music, the subset of digital content selected when the user selects icon 214 may be all audio files having “Country” music songs stored therein. Although the example described herein has used music genres as a way to differentiate the sets of tags with respect to the first row of icons 202, the sets of tags are not limited to such differentiation and may be defined as any number of different sets of tags related to the library of digital content. For example, the sets can include different groupings of artists, song titles, time periods, countries, languages, etc.

The interface 200 also includes a first column of icons 204, each icon in the first column of icons 204 is also associated with one or more tags that describe digital content included in the library of digital content. Each icon in the first column of icons 204 is located at the left of a row of icons representing different portions of the digital content that corresponds with the tags associated with the icon located at the left of the row of icons.

Returning to the example described above, as shown in FIG. 2A, the first column of icons 204 includes seven icons. Each of the seven icons may be associated with a set of tags that includes one or more tags. Again, the first icon, icon 212, in the first column of icons 204 is associated with the set of tags, X. Each of the other icons in the first column of icons 204 may be associated with different sets of tags, Bᵢ, which are different from the sets Aᵢ described above. Like the sets Aᵢ, each set Bᵢ may represent a subset of tags included in set X. For example, if the library of digital content comprises audio files, then each set Bᵢ may represent tags associated with different time periods of music whereas each set Aᵢ may represent tags associated with the different genres of music. Set B₁ may include all tags related to a “New” time period (e.g., music released within the last 6 months, 1 year, etc.); set B₂ may include all tags related to a “10s” time period (i.e., music released in between the year 2010 up to the current year, excluding music included in the “New” time period); and so forth.

In one embodiment, each icon in the first row of icons 202 and the first column of icons 204 may include a label overlaid on a graphical representation of the icon. The label may be a textual description of the set of tags associated with the icon. For example, a label for icon 212 may be “TOP OF” that indicates icon 212 selects all of the items in the library of digital content and processes the top items in the library. Similarly, a label for icon 214 may be “Top of Country” that indicates icon 214 selects a subset of items in the library of digital content related to Country music and processes the top items in the Country music subset. Of course, the graphical representation of the icon may not include text and may include a logo or other indication of the functionality of the icons.

In one embodiment, each icon in the first row of icons 202 and the first column of icons 204 may be selected in order to process a highest rated subset of items from the library of digital content. In other words, each icon in the first row of icons 202 associated with a set of tags Aᵢ may be selected to process a number (e.g., 40) of the highest rated items associated with that set of tags. Even though the library of digital content may include a much larger number of items related to that set of tags, only a number of highest rated items may be selected for processing. For example, selecting an icon associated with the “Top of Country” may select the top 40 country songs included in the library of digital content for processing.

Similarly, each icon in the first column of icons 204 associated with a set of tags Bᵢ may be selected to process a number of the highest rated items associated with that set of tags. The number of items selected for icons in the first row of icons 202 and the number of items selected for icons in the first column of icons 204 may be the same or may be different. For example, each icon in the first row of icons 202 may be associated with 40 items of digital content and each icon in the first column of icons 204 may be associated with 50 items of digital content. In addition, the first icon 212 may be selected to process a different number of highest rated items in the entire library of digital content, such as the top 100 items.

The interface 200 may also include other icons that are not included in the first row of icons 202 or the first column of icons 204. The interface 200 will include at least one other icon whenever the matrix comprises at least two rows of icons and at least two columns of icons. Each of these other icons may be used to select a subset of digital content for processing. The particular subset of digital content selected for processing in response to a user selecting a particular icon is a function of the sets of tags associated with two corresponding icons in the first row of icons 202 and the first column of icons 204. In one embodiment, for a particular icon in a particular row and a particular column of the interface 200, such as icon 218, a first subset of digital content is generated that includes all digital content in the library associated with at least one tag that corresponds to the set of tags associated with the icon at the top of the particular column, such as icon 214. A second subset of digital content is generated that includes all digital content in the library associated with at least one tag that corresponds to the set of tags associated with the icon at the left of the particular row, such as icon 216. The first subset of digital content is intersected with the second subset of digital content to select all digital content that is in both the first subset of digital content and the second subset of digital content. In other words, any digital content selected in response to a user selecting a particular icon located at a particular row and particular column in the interface 200 will be associated with at least one tag included in the set of tags (Aᵢ) associated with the icon at the top of the particular column and at least one other tag included in the set of tags (Bᵢ) associated with the icon at the left of the particular row.

It will be appreciated that, in alternate embodiments, the first row of icons 202 and the first column of icons 204 may be located at different locations relative to the rest of the icons in the matrix interface. For example, the first row of icons 202 may be located at the bottom of the display under the additional icons in the matrix interface. Similarly the first column of icons 204 may be located at the right of the display to the right of the additional icons in the matrix interface. Furthermore, the first row of icons 202 and the first column of icons 204 may be located somewhere in the middle of the display such that additional icons are located both above and below or to the left and the right of the respective first row of icons 202 and the first column of icons 204.

In one embodiment, each icon in the interface 200 may include an action symbol 230, such as the “Play” symbol, overlaid on the icon. The action symbol 230 may represent an action that will be taken when the user touches, clicks, or otherwise selects the icon. For example, the “Play” symbol may indicate that the digital content will be played (e.g., a video will be presented on a display device, audio will be streamed over one or more connected speakers, etc.). Other types of action symbols 230 are also contemplated as being within the scope of the present disclosure such as a “Favorite” symbol that enables a user to add the digital content represented by the icon to a list of digital content preferred by the user, a “Follow” symbol that enables a user to follow a particular channel of streaming digital content (e.g., a radio station channel, TV channel, artist channel, etc.), a “Pause” symbol or “Stop” symbol that enables a user to pause or stop digital content from being played, a “Skip” symbol that causes the content to be advanced to another content associated with the icon, a “Mute” symbol that causes the speakers to be disabled while the content continues to play, or a “Share” symbol that enables a user to share the digital content or a link to the digital content with a contact via, e.g., email, text message, a social media. API, or the like. It will be appreciated that the action symbols 230 described above may take any shape or design, may be overlaid on the icon as opaque or partially transparent, and are not exclusive such that other types of actions may be enabled by various other symbols. In some embodiments, only a subset of icons in the interface 200 may include an action symbol. For example, all other icons that are not included in the first row of icons 202 or the first column of icons 204 may include an action symbol 230.

In one embodiment, each of the icons may include a graphical representation of the digital content associated with that icon. The graphical representation may be a thumbnail version of a larger image associated with the digital content. For example, a particular icon in the matrix may represent a streaming audio channel, and the particular icon may include a thumbnail of the cover art for the album of the song currently being streamed as part of the streaming audio channel. Thus, each time a new song is started within the streaming audio channel, the particular icon may be updated to display a thumbnail associated with the new song. Again, the action symbol 230, such as the “Play” symbol, may be overlaid over the thumbnail content and may be opaque or partially transparent.

In addition, the graphical representation of the icons may be static or dynamic. In other words, the icons may include a static thumbnail or may include a dynamic video. For example, when the digital content includes video data, the icon may include a reduced resolution version of the digital video content or a slideshow of thumbnail versions of a subset of frames included in the digital video content such that the user has a preview of the video associated with that icon in another example, when the icon is associated with multiple files, such as multiple images or multiple audio files associated with album art, the icon may include a low resolution slideshow of a plurality of images associated with the multiple files so the user has a preview of the various files associated with a particular icon. Conversely, the icon may not show any content related to the digital content associated with the icon. For example, the icon may simply be displayed as a rectangle of a particular constant color or may display an image that includes a logo corresponding to the streaming audio channel or streaming video channel associated with the icon.

In one embodiment, the library of digital content is represented by a relational database that associates each item included in the library of digital content with one or more tags associated with that item. For example, the library of digital content may include a plurality of audio files and the relational database may include key value pairs that associate tags to pointers/handles for each particular file associated with the tags. The library of digital content may include files or streams. As used herein, a file represents data stored in a memory that may be referenced by a handle (i.e., filename, etc.) to the digital content. Files may be stored locally on the device or may be stored on a server connected to the device via a network and referenced using an identifier in order to retrieve the data. Examples of files are digital movies stored in a particular digital video format (e.g., MP4, H.264, etc.) or digital audio stored in a particular digital audio format (e.g., MP3, AAC, etc.). As used herein, a stream represents digital content associated with a channel that is broadcast to one or more users. Streaming content is typically pushed to the device by a streaming source that controls the playback of content within the streaming channel. Examples of streams are radio stations, television stations, and RSS feeds. Although radio stations and television stations typically stream content via radio waves in, e.g., the MF (Medium Frequency) band, VHF (Very High Frequency), and UHF (Ultra High Frequency) bands, digital versions of this content may also be streamed via the Internet by capturing the digital audio/video content and broadcasting that content in IP packets. It will be appreciated that any type of digital content may be streamed and streaming channels are not limited to audio and video content.

In one embodiment, the interface may be implemented by a developer by linking a library for the matrix interface to a source code and creating a new instance of the interface using functionality provided by the library. The library may include functions for defining the size of the interface, an appearance of the interface, linking a library of digital content to the interface, and so forth. A developer may associate each icon in the first row of icons 202 in the interface 200 with different sets of tags defined by the developer. Similarly, the developer may associate each icon in the first column of icons 204 in the interface 200 with different sets of tags defined by the developer. Once the interface has been defined and linked to a library, the interface may be configured to query the database to returns a subset of digital content in the library in response to a user selecting one of the icons in the interface 200. The subset of the digital content may be generated by querying the database based on the tags associated with that icon.

Again, the interface 200 may be linked to a library of digital content. Such digital content varies, but includes at least a plurality of streaming audio channels, a plurality of streaming video channels, a plurality of streaming image channels (i.e., slideshows, Tumblr® feed, etc.), a plurality of text channels (i.e., text feeds, RSS channels, etc.), or a plurality of application channels (i.e., flash-based applications, javascript-based applications, etc.).

In one embodiment, the interface 200 also includes control icons 220. FIG. 28 illustrates the control icons 220 of the interface 200 of FIG. 2A, in accordance with one embodiment. The control icons 220 may be used for receiving feedback from a user. For example, some of the control icons 220 may enable the user to indicate whether the user likes or dislikes the currently selected digital content. The preferences of a single user may be tracked in order to tailor the content associated with the interface to the particular user. Similarly, the preferences of a plurality of users may be tracked in order to tailor the content associated with the interface to the plurality of users. The interface 200 may also include other control icons 220 for controlling the operation of the device, such as enabling the user to control the playback of audio or video by using a play command, a pause command, a skip track command, and the like.

In one embodiment as shown in FIG. 2B, the control icons 220 include a “Plus” icon 222, a “Minus” icon 228, a “Play” icon 224, and a “Skip” icon 226. The “Plus” icon 222 and “Minus” icon 228 enable a user to indicate whether they like or dislike the currently selected digital content. An application on the device or an application on a server computer connected to the device via a network may keep track of the types of content that a user likes and dislikes and adjust the types of digital content included in the library associated with the interface 200. The “Play” icon 224 and “Skip” icon 226 may be used to start the processing of particular digital content or skip to a different digital content, respectively. In one embodiment, when a user selects the “Skip” icon 226, a frequency value associated with the current content will be adjusted as described in the functionality of the “Short Minus” icon 616, set forth in more detail below. It will be appreciated that other types of control icons may be included in the interface 200 in addition to or in lieu of the control icons 220 shown in FIG. 2B and that the example control icons 220 are not exhaustive. Other functionality for control icons 220 that may be implemented in the interface 200 include: “Play”, “Pause”, “Stop”, “Skip”, “Mute”, volume controls, equalizer levels, etc. Furthermore, the control icons 220 may not be included in some embodiments or may be initially hidden and included in a different interface that is overlaid on top of interface 200 when the user selects a particular icon in the interface 200 to select a subset of digital content.

With respect to the preferences of a user for particular types of digital content, the application on the device or on the server may be configured to select an order of digital content to be processed from the subset of digital content selected by a user based on a priority. For example, when the user selects a particular icon in the interface 200, a subset of digital content will be selected for processing. In order to prioritize which item in the subset of digital content is processed first, the application may utilize information related to the user's preferences, as provided via feedback from the “Plus” icon 222 and the “Minus” icon 228. Priority information may be utilized to select an overall ordering of the items of digital content that have been selected for processing, such as by generating a playlist based on a decreasing priority order, in which each item is ordered to be processed once before all remaining items are processed. In another implementation of the application, items are processed randomly based on a weighted priority of the items of digital content. In such implementations, some items may be processed more than once before other items in the subset of digital content are processed for the first time. In this manner, more preferred items may be processed more frequently that less preferred items.

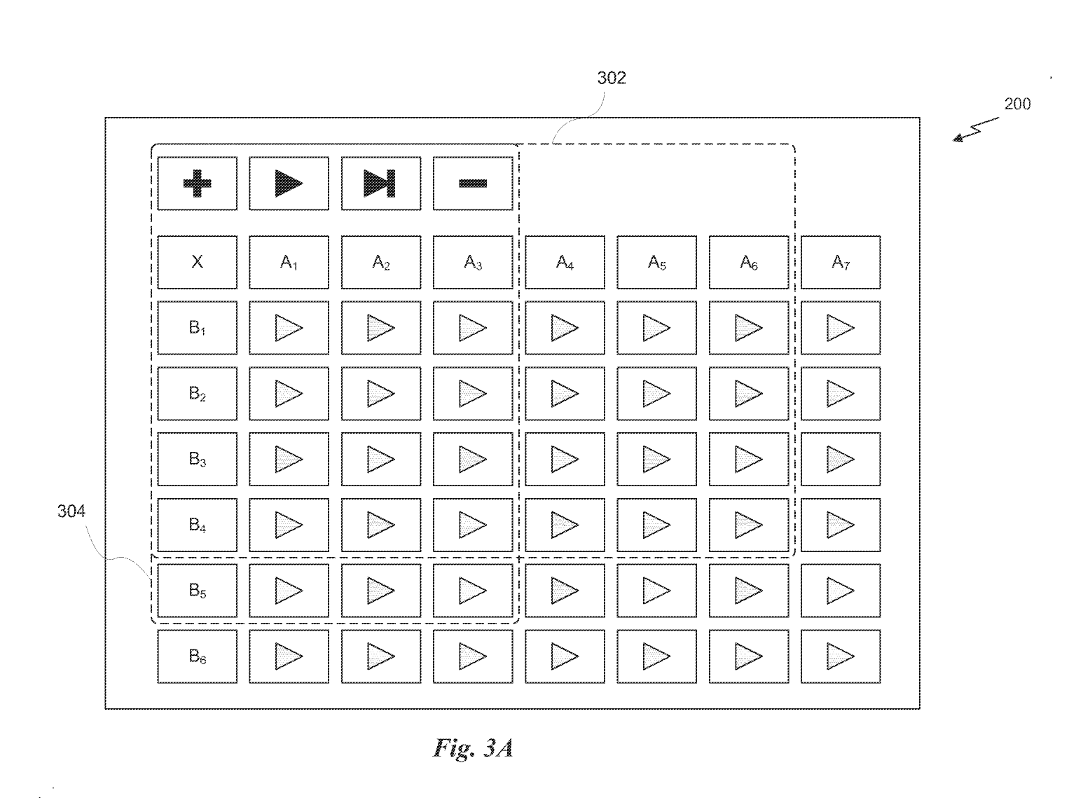

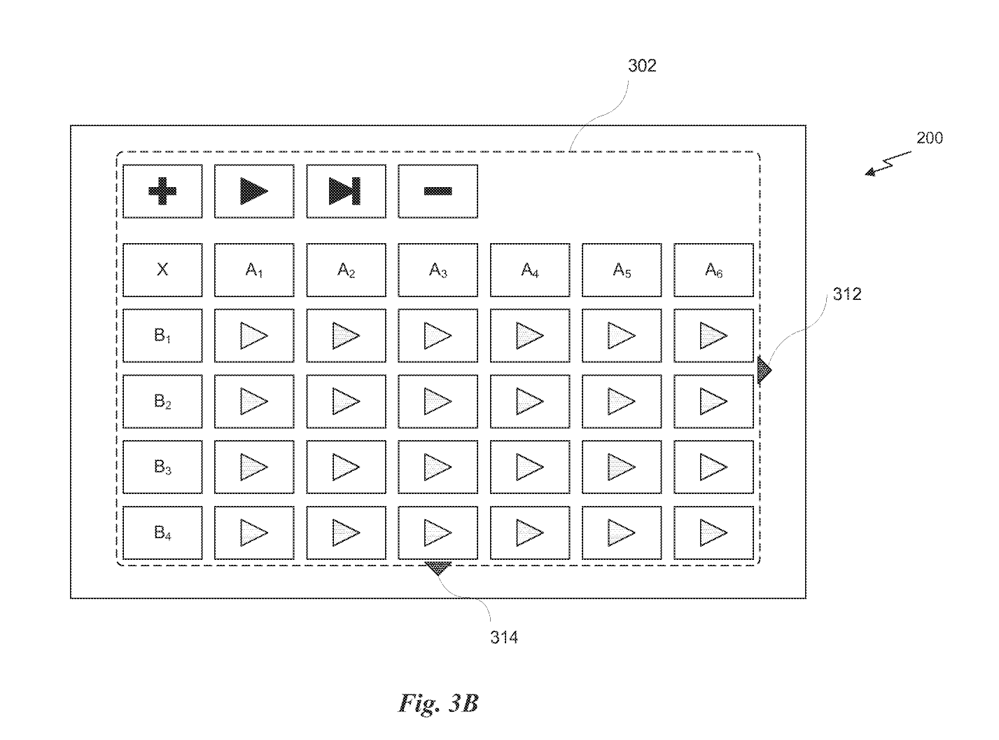

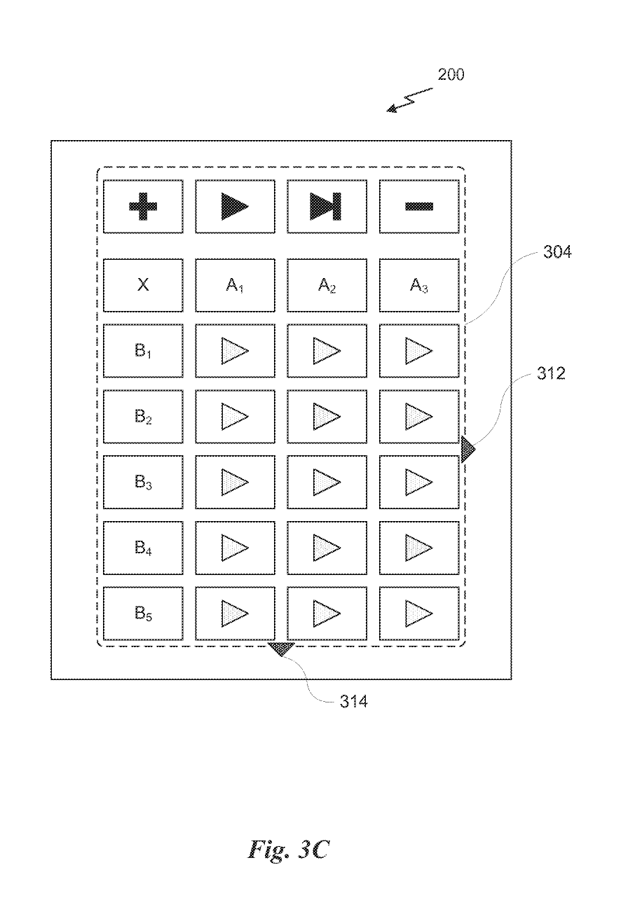

FIGS. 3A through 3C illustrate the interface 200 displayed on multiple platforms, in accordance with one embodiment. Each device in a plurality of different devices, such as a desktop computer, a tablet computer, and a mobile phone, may implement at least a portion of the interface 200 using a display associated with the device. As shown in FIG. 3A, a desktop computer may be associated with a monitor (e.g., LCD display, OLED display, LED display, etc.) that has a native resolution large enough to display the interface 200 such that the full interface may be implemented on the desktop computer. However, the native resolutions of the displays associated with a tablet device and/or a mobile phone may be smaller than the native resolution of the desktop. In such cases, the interface 200 may need to be scaled in order to fit on the extents of the displays of these devices. However, scaling the interface 200, such that the icons are smaller than the original version of the interface, may create issues with ease of use for a user. For example, making the icons too small may make it difficult for a user to select a particular icon using touch input on a smaller display device, in such cases, only a portion of the interface 200 may be displayed on the display of the different devices at any given time and other portions of the interface 200 may be displayed in response to user input such as a scrolling input or a navigation input. In such embodiments, the icons may have substantially the same appearance on the tablet as on the desktop computer, just with fewer icons included on the screen at any one time. As described below, even though a smaller number of rows or columns of icons of the interface 200 may be displayed on the other devices, the additional icons, that are not initially displayed, may be navigated to using additional user interface elements or functionality. It will be appreciated that in some implementations of the interface 200, the number of icons included in the interface 200 may not be displayed adequately on the native resolution of a monitor for a desktop computer or laptop computer and, in such implementations, the interface 200 may also include the ability to navigate to other portions of the interface 200 such that the entire interface 200 is not necessarily displayed on the screen at any one time.

As shown in FIG. 3A, a first portion 302 of the interface 200 may be selected for use in a tablet device that has a smaller native resolution than, for example, a desktop monitor or 17″ laptop screen. Similarly, a second portion 304 of the interface 200 may be selected for use in a mobile device that has a smaller native resolution than the tablet device. The particular portions shown in FIG. 3A are chosen for illustrative purposes only and the actual portions of the interface selected for presentation on a display of a device may be chosen based on the size and resolution of the display.

FIG. 3B illustrates the first portion 302 of the interface 200 as displayed on a tablet device, in accordance with one embodiment. As noted above, the first portion 302 does not include all of the icons of the interface 200. As such, additional user interface elements may be overlaid on top of the interface 200 to indicate that additional icons are initially hidden. In one embodiment, navigation buttons 312 and 314 are shown to indicate that the user can navigate to additional columns of icons or rows of icons, respectively. When compared to interface 200 of FIG. 3A, the first portion 302 does not include an additional column of icons (i.e., the column associated with set A₇) or two additional rows of icons (i.e., the rows associated with sets B₅ and B₆). As such, the user may select the navigation buttons 312 and 314 to change which columns and/or rows of icons are currently displayed on the display associated with the device. In one embodiment, at least a portion of the first row of icons 202 and the first column of icons 204 remain displayed on the device at all times to provide a user context for the other icons currently displayed. For example, when a user scrolls left to right or right to left to display additional columns of icons, the first column of icons 204 remains fixed on the left side of the screen while the other columns of icons may be shifted on or off the extents of the display. Similarly, when a user scrolls top to bottom or bottom to top to display additional rows of icons, the first row of icons 202 remains fixed on the top of the screen while the other rows of icons may be shifted on or off the extents of the display. It will be appreciated that a user may navigate to other portions of the interface 200 by selecting the navigation buttons 312 and 314. Alternatively, the navigation buttons 312 and 314 may simply be displayed in order to indicate to a user that not all portions of the interface 200 are displayed on the screen. In such embodiments, the interface 200 may implement any other type of navigation functionality well-known in the art such as a scrollbar or touch-based input (e.g., swiping across a touch-based display).

FIG. 3C illustrates the second portion 304 of the interface 200 as displayed on a mobile device, in accordance with one embodiment. Again, the second portion 304 does not include all of the icons in the interface 200 and, therefore, navigation buttons 312 and 314 may be displayed to indicate the user can navigate to additional columns of icons or rows of icons, respectively. It will be appreciated that the operation of navigating to the additional icons may be performed based on user input such as a selection of the navigation buttons 312 or 314 (e.g., via mouse click or touch based input), use of a scroll bar, swiping a finger across a touch-sensitive display device, or the like. In addition, the form and style of the navigation buttons 312 and 314 may be modified to have any appearance or take any form that indicates to the user that additional icons of the interface are not currently presented on the display device.

In one embodiment, the interface 200 may be programmed in a device-independent program language and included in the applications developed for different devices, wherein the application is configured to select a portion (e.g., 302, 304, etc.) of the interface 200 to display based on the particular device the application is executed on. In such embodiments, the portion of the interface 200 selected to be presented may be different depending on what device the application is running on, but the overall user experience when using the application on different devices remains familiar.

For example, the interface 200 could be embodied as a device independent library that can be included in the code for a variety of different platforms or operating systems such as Windows®, X11, and Linux®. In one embodiment, the device-independent programming language is Java®. In another embodiment, a different interface may be programmed in each particular environment associated with the different devices in a manner that the different interfaces have a similar appearance in style, but each interface may present a different portion of the interface 200 on a particular screen based on a size of the display associated with the device. For example, the interface for a desktop application may be programmed using the Microsoft® Visual Studio IDE (Integrated Desktop Environment) using C++ or C# whereas a mobile application for display on a tablet or mobile phone may be programmed using the Apple® Xcode IDE. Even though the interfaces for the different devices may be programmed separately, they may be designed to have a similar appearance, style, and arrangement.

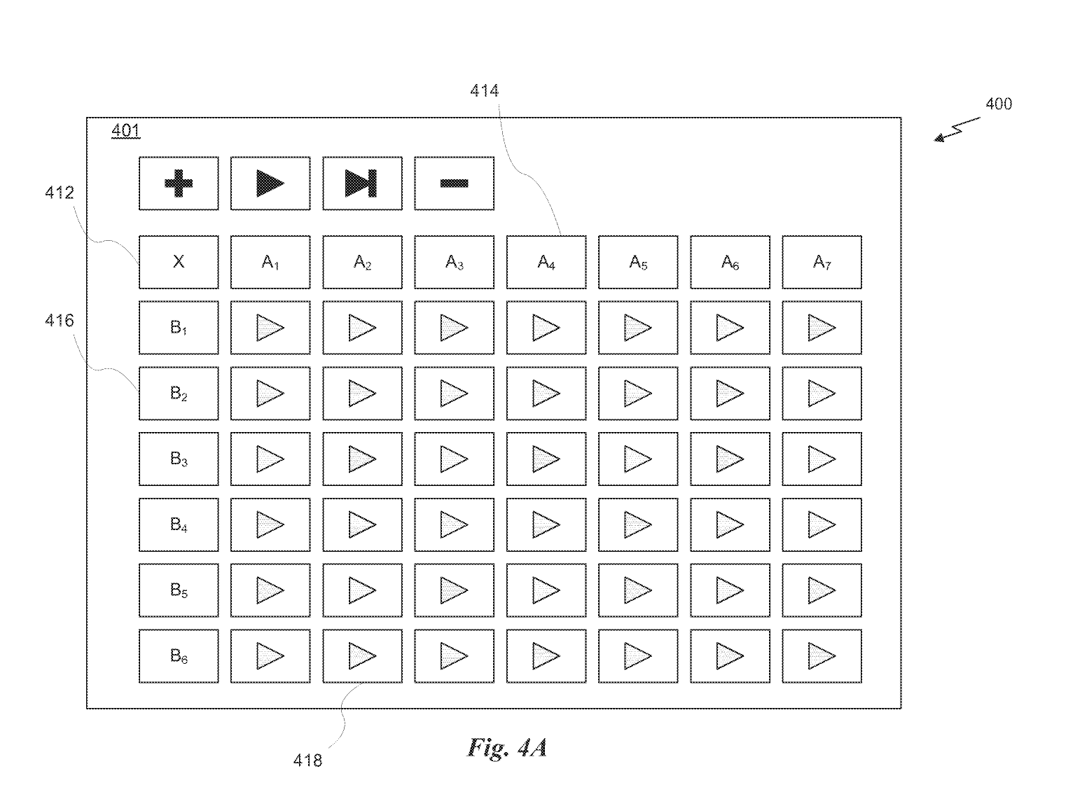

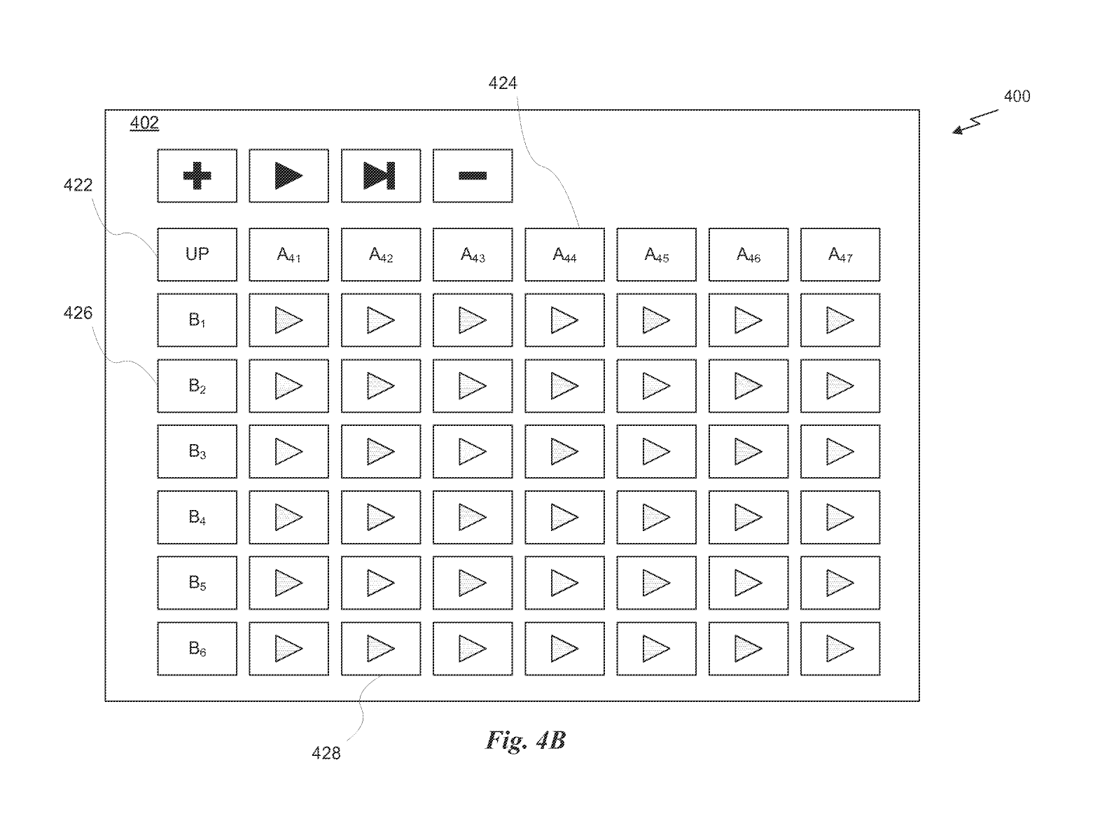

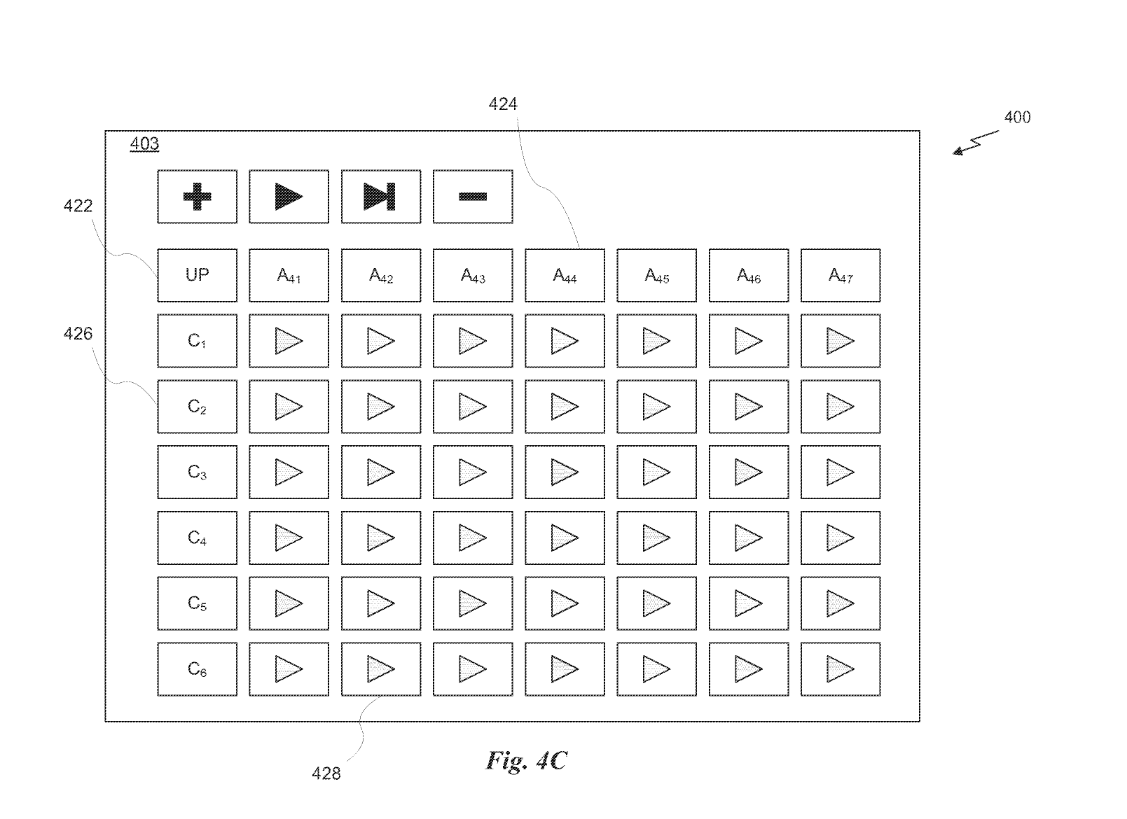

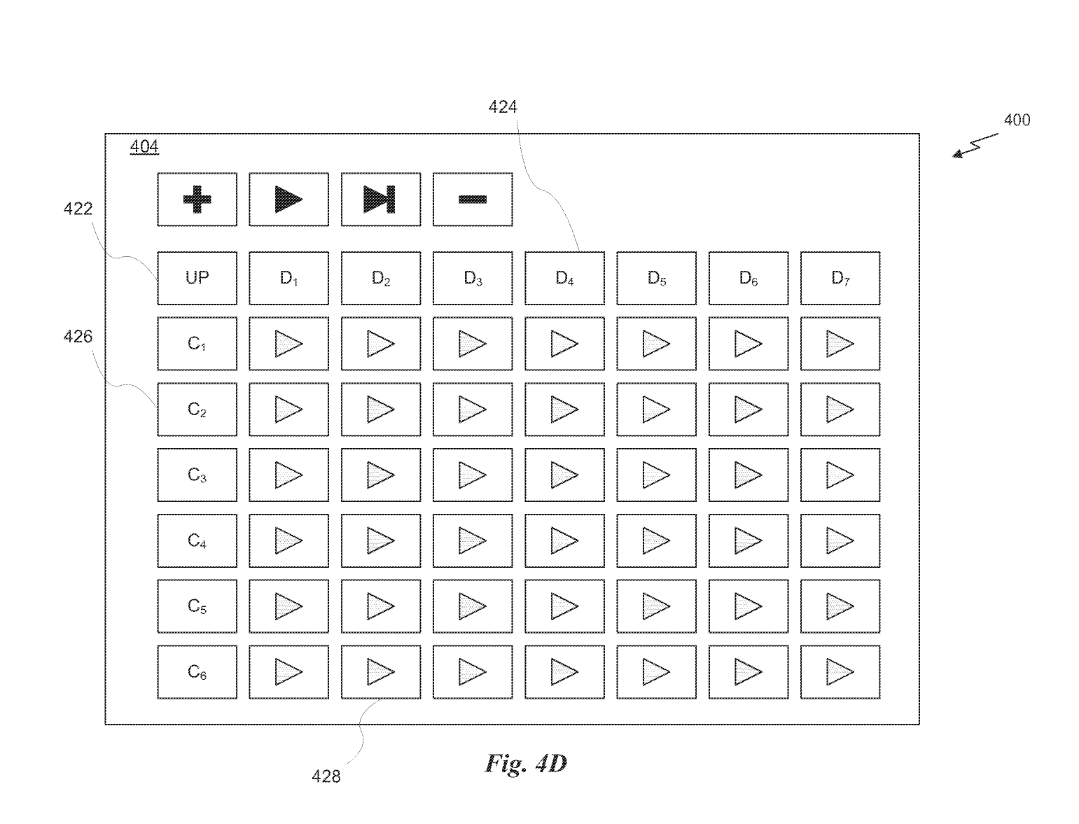

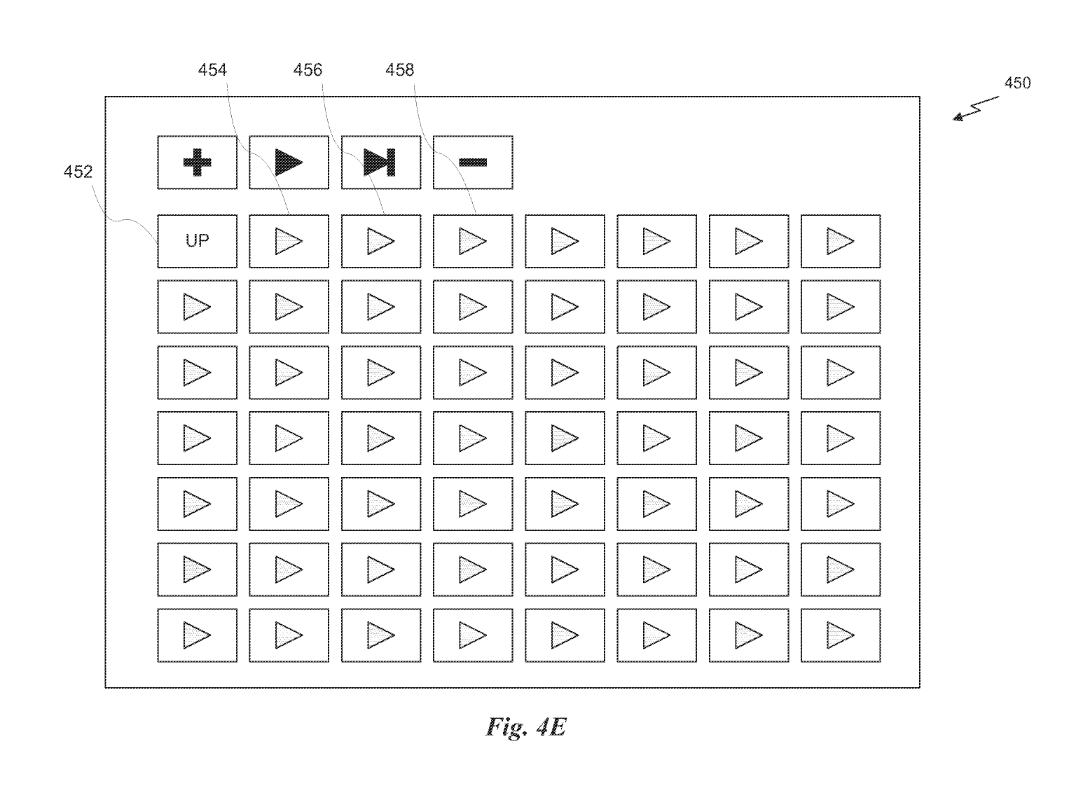

FIGS. 4A through 4E illustrate a hierarchical matrix interface 400, in accordance with another embodiment. As described above, the matrix interface 200 provides a GUI interface for selecting digital content for processing from a library of digital content. This interface has a single hierarchical level in which all icons included in the interface 200 are displayed on a top level of the interface 200. However, in some instances, it makes more sense to create a hierarchical matrix interface with two or more levels. For example, a hierarchical matrix interface 400 may be more efficient for a user when the library of digital content is particularly large, the individual items of content are large (such as with digital movies), or the classification of such content has a large number of separate and distinct classifications such that the number of columns or rows of icons for the interface 200 would become much larger than can fit on any one display.

As shown in FIG. 4A, a first-level 401 of the hierarchical matrix interface 400 is similar to the interface 200 of FIG. 2A. Except where specifically noted, the functionality of the icons in interface 400 may be similar to the functionality of the icons in interface 200, as described above. More specifically, each of the icons in the first row of icons of interface 400 is associated with a set of tags Aᵢ with the exception of the first icon, icon 412. Again, in some embodiments, the first icon 412 may be associated with a set of tags X that embodies all tags associated with the items in the library of digital content, or, alternatively, icon 412 may not be associated with any set of tags and may be blank and left as a placeholder for other functionality implemented in other levels of the hierarchical matrix interface 400. Similarly, each of the icons in the first column of icons of interface 400 is associated with a set of tags Bᵢ with the exception of the first icon 412. Furthermore, as an example, a particular icon 414 in the first row of icons of interface 400 is associated with a set of tags A₄, a particular icon 416 in the first column of icons of interface 400 is associated with a set of tags B₂, and a particular icon 418 of interface 400 is associated with a set of tags A₂ and a set of tags B₆. Again, in some embodiments, icons in the first row of icons or the first column of icons may be used to select a number of highest rated content associated with the set of tags corresponding to that icon and the first icon 412 may be used to select a number of highest rated content for the entire library of digital content, as described above.

Unlike interface 200 described above, when a user selects an icon in the first-level 401 of the hierarchical matrix interface 400, another level of the hierarchical matrix interface 400 may be displayed. For example, when the user selects icon 414, which is associated with the set of tags A₄, a second level 402 of the hierarchical matrix interface 400, as shown in FIG. 4B, may be displayed in order to select a subset of the digital content associated with the set of tags A₄. In the second-level 402 of the hierarchical matrix interface 400, the first row of icons in the top-level of interface 400 is replaced with a new row of icons in the second-level of interface 400. For example, icon 412 is replaced with icon 422, which enables a user to navigate up to the top-level of the hierarchical matrix interface 400. In addition, each of the other icons in the first row of icons is associated with a subset of tags, wherein each subset of tags associated with a particular other icon in the first row of icons includes a portion of the tags associated with the icon 414 in the top-level of the hierarchical matrix interface 400. In other words, the second-level 402 of the hierarchical matrix interface 400 is used to expand a single column of the top-level 401 of interface 400 into a plurality of columns in the second-level 402 of the interface 400.

As also shown in FIG. 49, the first column of icons in the second-level 402 of the hierarchical matrix interface 400 may remain the same as the first column of icons in the top-level 401 of the hierarchical matrix interface 400, with the exception of icon 412/422 as discussed above. In other words, selecting an icon in the first row of icons of interface 400 causes the corresponding column to expand to multiple columns in a new level of the hierarchical matrix interface 400 while the sets of tags associated with the various rows of icons of the interface 400 remain the same. Conversely, although not shown explicitly, selecting an icon in the first column of icons of interface 400 causes the corresponding row to expand to multiple rows in a new level of the hierarchical matrix interface 400 while the sets of tags associated with the various columns of icons of the interface 400 remain the same.

Alternatively, as shown in FIG. 4C, the first column of icons in the second-level 403 of the hierarchical matrix interface 400 may be changed to use different sets of tags, sets Cᵢ. For example, whereas the sets of tags Bᵢ shown in the top-level 401 of the interface 400 may be related to time periods, the sets of tags Cᵢ shown in the second-level 403 of the interface 400 may be related to a country of origin. In this manner, a particular column of the top-level 401 of the interface may be expanded into multiple columns having subsets of tags related to that particular column in the top-level 401, which simultaneously rearranging the rows of the second-level 403 of the interface 400 based on entirely new sets of tags Cᵢ.

In addition, as shown in FIG. 4D, the first row of icons and the first column of icons in the second-level 404 of the hierarchical matrix interface 400 may be changed to use different sets of tags, sets Cᵢ and Dᵢ. In other words, once a selection of a particular icon in the top-level 401 of the interface 400 is made, the sets of tags associated with both the first row of icons and the first column of icons in the second-level 404 of the interface 400 may be changed and totally unrelated to the sets of tags Aᵢ and Bᵢ associated with the first row of icons and the first column of icons in the top-level 401 of the interface 400.

It will be appreciated that any of the second-levels 402, 403, and 404 may be interchanged in a particular implementation of the hierarchical matrix interface 400 and that any number of the second-levels 402, 403, and 404 may be combined as a number of intermediate levels in a hierarchical matrix interface 400 having three or more hierarchical levels. For example, the hierarchical matrix interface 400 may be configured such that a user can expand a column of icons in the top-level 401 of the interface 400 to generate a second-level 402 of the interface 400 and then expand a row of icons in the second-level 402 of the interface 400 to generate a third-level (not explicitly shown) of the interface 400, or vice versa. The hierarchical matrix interface 400 may include any number of levels, per the developers desired implementation details.

In one embodiment, if the user selects an icon in the first row of icons or the first column of icons in a bottom-level of the hierarchical matrix interface 400, then a selection of digital content associated with the set of tags corresponding to that icon may be selected, as described above with respect to the matrix interface 200. In other embodiments, the selection of an icon may cause another interface 450 to be overlaid on top of the interface 400 to enable selection of particular items of digital content. As shown in FIG. 4E, if the set of digital content associated with the particular icon, such as icon 428, includes more than one item, then the interface 450 may be presented to the user to enable the user to select a particular item for processing. The interface 450 may be utilized even if none of the icons in the first row of icons or the first column of icons in the interface 400 are configure to be expandable into a second-level (i.e., the hierarchical interface 400 includes only a top-level that has one or more other icons, such as icon 418, that cause display of the interface 450 when selected).

Again, the interface 450 may be overlaid over the interface 400 when a particular icon is selected. The interface 450 may include a first icon 452 that enables the user to navigate back to the next higher level of the hierarchical matrix interface 400. Each of the other icons (e.g., icon 454, icon 456, icon 458, etc.) included in the interface 450 is associated with a different item in the subset of digital items associated with the particular icon. Thus, the interface 450 enables a user to select a particular item of digital content for processing from the subset of digital content associated with a particular icon in the lowest-level of the hierarchical matrix interface 400. Although not shown explicitly, the number of other icons shown may match the number of items of digital content associated with the selected icon in the parent level of the hierarchical matrix interface such that the number of icons in interface 450 does not match the number of icons in interface 400 (e.g., not all of the icons shown in FIG. 4E may be displayed if only a small number of items of digital content are associated with the selected icon in the parent level of the hierarchical matrix interface).

The interface 450 is useful, for example, when a large number of items are associated with a particular icon or when the type of content associated with the particular icon is not well suited to serial playback. For example, the interface may be used when selecting individual movies to play or when selecting individual albums associated with a particular artist, as well as in other instances.

In one embodiment, the expansion of the hierarchical matrix interface 400 into two or more hierarchical levels may be programmed (i.e., hard-coded) by a developer. In another embodiment, the expansion of the hierarchical matrix interface 400 into two or more hierarchical levels may be performed automatically based on the number of tags associated with the selected icon in the parent level of the hierarchical matrix interface 400. For example, the interface 400 may automatically separate the set of tags Aᵢ into a number of subsets of tags Aᵢⱼ, evenly distributing the tags in the set of tags selected at the parent level between the subsets of tags associated with icons in the child level. Multiple levels may be automatically expanded until each icon in the interface is associated with one or fewer tags.

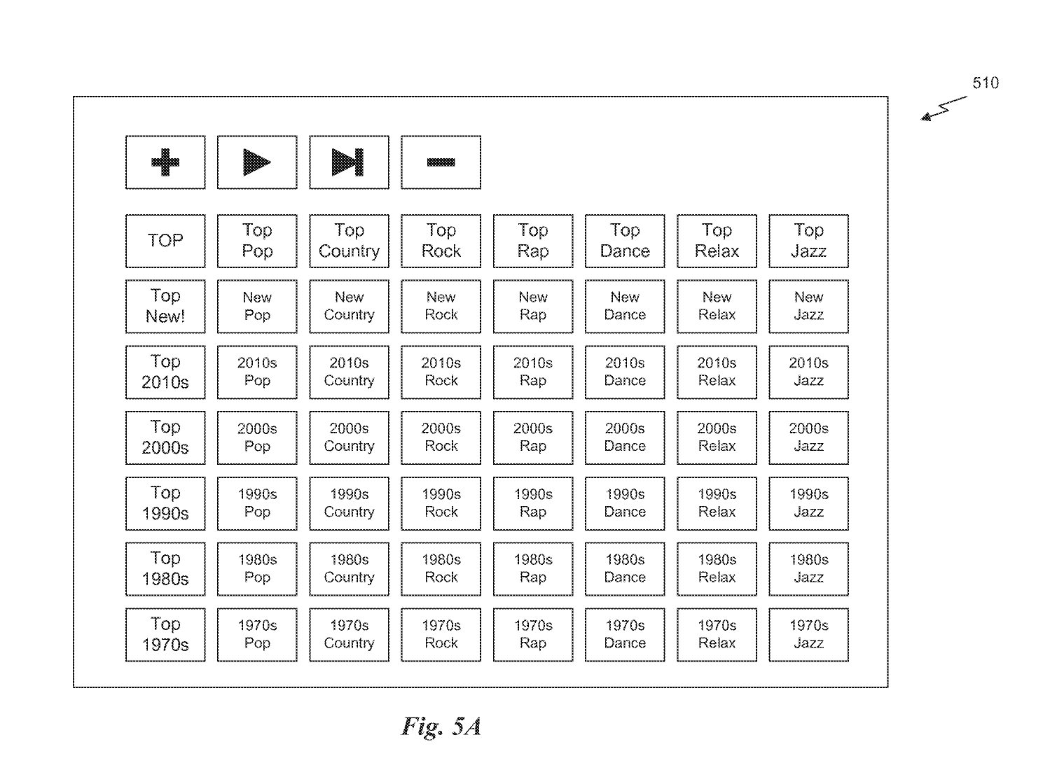

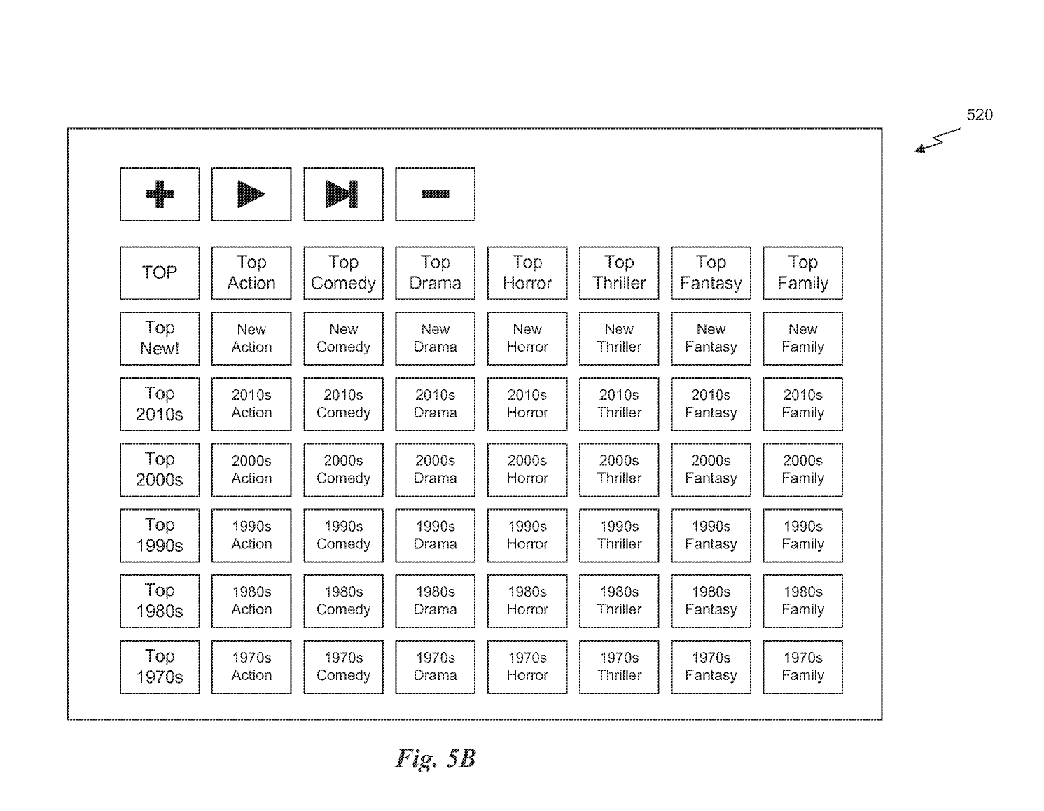

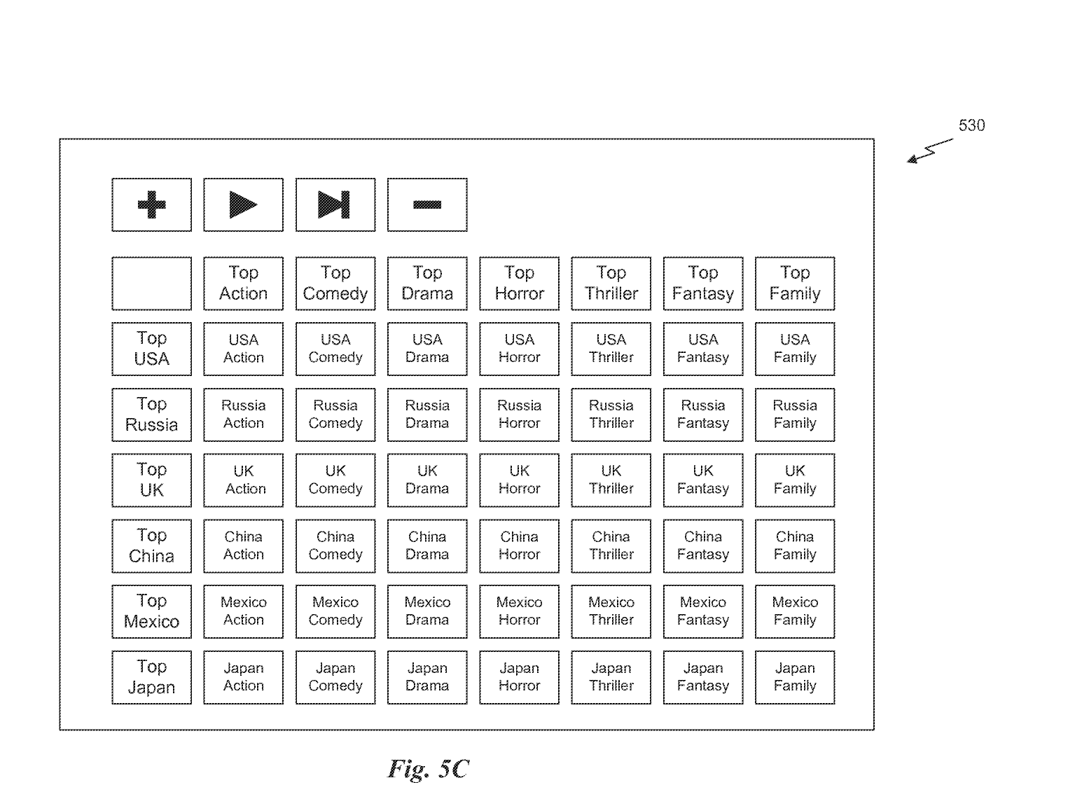

FIGS. 5A through 5C illustrate various implementations of the matrix interface for different types of digital content, in accordance with various embodiments. As shown in FIG. 5A, the matrix interface 510 shows one implementation of the interface 200 for use with a library of digital audio files. When a user selects any of the icons in the interface 510, the device may be configured to process (e.g., play, etc.) one of the audio files associated with that icon via speakers associated with the device. It will be appreciated that the “TOP” icon in both the first row of icons and the first column of icons is used to select a highest ranked subset of audio files from all audio files included in the library, the other icons in the first row of icons (e.g., “Top Pop”, “Top Country”, etc.) are used to select a highest ranked subset of audio files from a particular genre within the library of audio files, the other icons in the first column of icons (e.g., “Top New!”, “Top 2010s”, etc.) are used to select a highest ranked subset of audio files from a particular time period, and all of the remaining icons in the interface 510 are used to select a subset of audio files from both a particular genre and a particular time period. It will be appreciated that the second row of icons (i.e., those icons associated with the “New!” time period may be associated with newly released music such as any music released within the last 3 months, 6 months, 1 year, or so on. The particular length of time associated with the “New!” time period may be chosen by the developer. It will also be appreciated that while associating a time period of 3 months to 1 year may be appropriate for music, longer time periods may be appropriate for other content such as movies where a smaller amount of content may be associated with the same time period.

In one embodiment, some additional rows or columns of icons in the matrix interface 200 may only be associated with one set of tags corresponding to an icon at the left of the additional row or top of the additional column, respectively, instead of being associated with two sets of tags corresponding to the particular row and particular column of the icon. For example, the matrix interface 510 may include an additional column for a Classical music genre when the library of digital audio files includes classical music. However, classical music may not fit well with the time periods associated with the first column of icons in the matrix interface 510. In other words, most classical music was produced well before the 70s time period; and, therefore, an additional column of icons for the classical genre would not likely be associated with any content from time periods between the 70s and today. As one solution to this issue, the additional column of icons may be associated with a set of tags that is associated with a first icon in the additional column of icons that is also located in the first row of icons. Such icon may display a “Top Classical” label, for example. While each of the other icons in the additional column of icons will be associated with that set of tags, those icons will each be associated with a second set of tags that is not related to the sets of tags associated with icons in the first column of icons. Each of the other icons in the additional column of icons may be associated with a particular set of tags, such as a country of original for the classical music, a composer of the classical music, or a sub-genre of classical music, for example. It will be appreciated the examples of the second set of tags to associate with the icons in the additional column of icons is not exhaustive and any sets of tags used for differentiating between the different items of classical music may be used. Another example of content that would be amenable to the use of an additional column of icons is world music where each icon in the additional column of icons is associated with a set of tags for a particular country or region of the world.

As shown in FIG. 5B, the matrix interface 520 shows one implementation of the interface 200 for use with a library of digital video files. When a user selects any of the icons in the interface 520, the device may be configured to process (e.g., play, etc.) one of the video files associated with that icon via a video player application and display associated with the device. The video player application functionality may be provided within the same application as the interface 520 or may be provided by a separate external application stored on the device. It will be appreciated that the interface 520 is similar to the interface 510 except that the genres of music have been replaced by genres of movies. Again, the “TOP” icon in both the first row of icons and the first column of icons is used to select a highest ranked subset of video files from video files included in the library, the other icons in the first row of icons (e.g., “Top Action”, “Top Comedy”, etc.) are used to select a highest ranked subset of video files from a particular genre within the library of video files, the other icons in the first column of icons (e.g., “Top New!”, “Top 2010s”, etc.) are used to select a highest ranked subset of video files from a particular time period, and all of the remaining icons in the interface 520 are used to select a subset of video files from both a particular genre and a particular time period.

In another embodiment, the last row of icons (i.e., the row of cons associated with the 70s time period) may be associated with a particular time period that is longer than the other time periods. For example, the last row of icons may be associated with a time period “70s and before” that encompasses all dates up to and including the last day of 1979. Thus, all time periods are covered by the various time periods associated with the rows of the matrix interface 520. In some other embodiments, the time periods of the rows do not need to be uniform in size and any time period can be associated with any of the rows of icons.

As shown in FIG. 5C, the matrix interface 530 shows one implementation of the interface 200 for use with a library of streaming television channels. When a user selects any of the icons in the interface 530, the device may be configured to process (e.g., play, etc.) streaming video corresponding to one of the television channels associated with that icon via a video player application and display associated with the device. It will be appreciated that the interface 530 is similar to the interface 520 except that the time periods have been replaced by countries of origin for the particular streaming television channels. It will be appreciated that the first icon included in both the first row of icons and the first column of icons is blank and does not have any special functionality. In some embodiments, the first icon may be a placeholder for an icon in a subsequent level of a hierarchical matrix interface. The other icons in the first row of icons (e.g., “Top Action”, “Top Comedy”, etc.) are used to select a highest ranked subset of streaming television channels from a particular genre within the library of channels, the other icons in the first column of icons (e.g., “Top USA”, “Top Russia”, etc.) are used to select a highest ranked subset of streaming television channels from a particular country of origin fir the channels, and all of the remaining icons in the interface 530 are used to select a subset of streaming television channels from both a particular genre and a particular country of origin.

It will be appreciated that FIGS. 5A through 5C are only a small subset of examples of particular implementations of the interface 200 and that such examples are provided for illustration purposes and are not meant to be limiting in any way. Other examples of the interface 200 and/or the interface 400 are contemplated as being within the scope of the present disclosure.

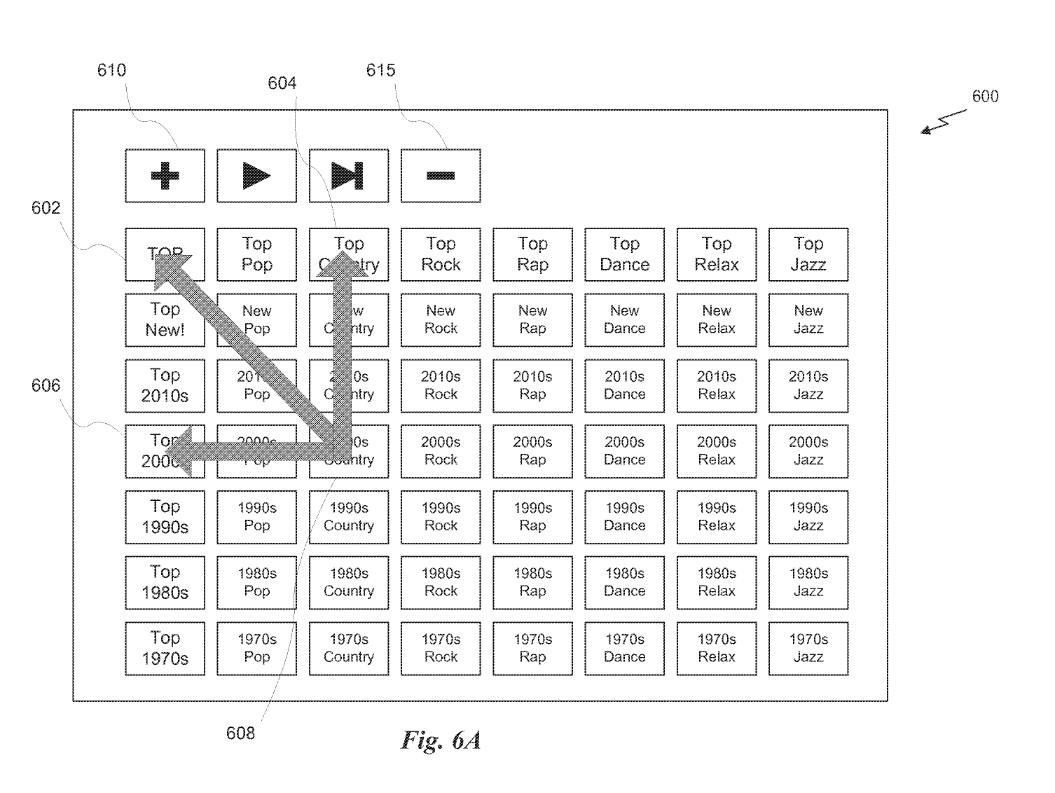

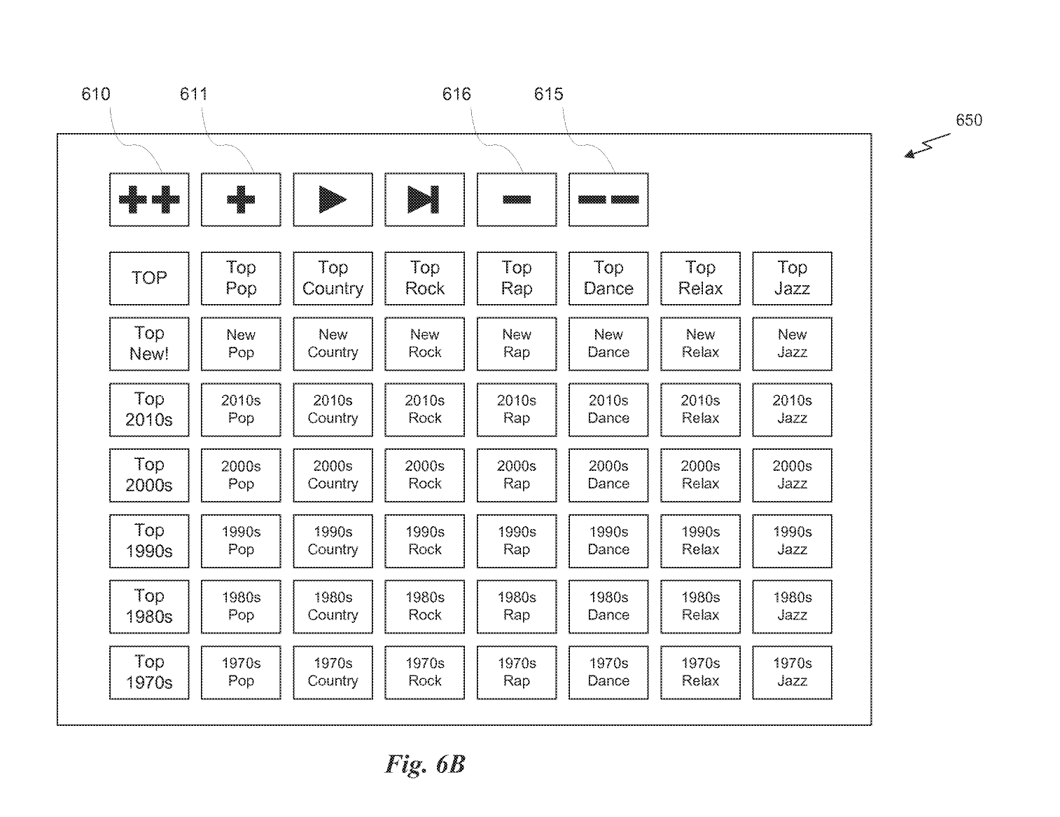

FIG. 6A illustrates the functionality associated with a set of control icons in an interface 600, in accordance with another embodiment. As shown in FIG. 6A, the interface 600 is similar to the interface 510, except as otherwise noted. The interface 600 may include control icons including a “Plus” icon 610 and a “Minus” icon 615. The icons 610 and 615 may be used to indicate user's preferences for particular digital content associated with the interface.

In one embodiment, a service that implements the interface 600 may track which songs a user likes or dislikes and adjust the content associated with each icon in the interface 600 accordingly. For example, when a user first uses the interface 600, the service may rank each of the songs included in a library of digital audio files. The service may create a default list of the top songs associated with each music genre and each time period. Thus, when the user selects one of the “Top . . . ” icons in the first row of icons or the first column of icons in the interface 600, the service may select the subset of songs processed for those icons based on the default lists. However, the user may use the icons 610 and 615 to adjust the songs included in these lists for the particular user thereby changing which songs have the highest ranking for the particular user.

In one embodiment, a user may select a particular icon in the interface 600, such as the “2000s Country” icon 608. The interface 600 may begin processing the songs associated with both the Country music genre and the 2000s time period. If the user likes a particular song currently being played, the user may indicate his preference to the service using the “Plus” icon 610. By selecting the “Plus” icon 610, the service may adjust the ranking of songs as stored in the default list. For example, the service may add the song to the list as the highest ranked song and remove the lowest ranked song from the list. Each time a user adds a song to the list using the “Plus” icon 610, the currently playing song may be added to the list as the highest ranked song and every other song in the list may be decreased in rank by one. Therefore, the list always includes the most recently liked songs according to that user. Conversely, if a user does not like a particular song, then the user may indicate his preference to the service using the “Minus” icon 615. The service may maintain a separate list of songs that the user dislikes that are excluded from the list of highest ranked songs associated with a particular genre or a particular time period, for example.

In some embodiments, the service may remove that song from the library of digital content such that the song will no longer be played if the user selects any of the icons in the interface 600. In other embodiments, the service may only prevent that song from being played when the user selects one of the icons in the first row of icons or the first column of icons in the interface 600. For example, that song would not be played if the user selects the icon 602 (“Top”), the icon 604 (“Top Country”), or the icon 606 (“Top 2000s”), but could still remain in the library of digital content and may be played again if the user selects icon 608 (“2000s Country”). Such embodiments may enable the user to change their minds about the song at a later point in time and indicate their change in preference by using the “Plus” icon 610 at that point to negate their earlier use of the “Minus” icon 615.

It will be appreciated that when a user selects the “Plus” icon 610 for a particular song being played after the user clicks an icon in the interface, such as icon 608, the particular song being played may be added to a list associated with an icon at the top of the column of icons for that icon, such as icon 604; a list associated with an icon at the left of the row of icons for that icon, such as icon 606; and a list associated with a first icon in the interface associated with the “TOP” content for the library, such as icon 602. Similarly, when a user selects the “Minus” icon 615 for a particular song being played after the user clicks an icon in the interface, such as icon 608, the particular song being played may be removed from these lists.

The service may store lists ranking songs or other content for particular users, thereby tailoring the experience using the interface 600 to each particular user. In addition, the service may update default rankings for the content included in the digital library based on the combined feedback of a plurality of users. In other words, even if a particular user does not use the “Plus” icon 610 or the “Minus” icon 615, the content selected for the “Top . . . ” icons may still be based, at least in part, on the preferences of other users based on the default lists.

FIG. 6B illustrates the functionality associated with a set of control icons in an interface 650, in accordance with yet another embodiment. As described above in FIG. 6A, the service may utilize feedback from users in order to tailor content associated with the “Top . . . ” icons included in the first row of icons and the first column of icons. The functionality enabled by the “Plus” icon 610 and the “Minus” icon 615 is only one such type of functionality that may be implemented in accordance with the interfaces 600 or 650.

As shown in FIG. 6B, the interface 650 may include a “Long Plus” icon 610 and a “Long Minus” icon 615 that enables the functionality described above in association with FIG. 6A. In addition, the interface 650 may include a “Short Plus” icon 611 and a “Short Minus” icon 616 that enables different functionality for indicating user preferences for particular songs. While the “Long Plus” icon 610 and the “Long Minus” icon 615 cause a service to change the ranking of songs included in the digital library, thereby adjusting which songs are selected as a subset of highest ranked items associated with icons in the first row of icons and the first column of icons, the “Short Plus” icon 611 and a “Short Minus” icon 616 may cause a service to simply change the frequency a particular item is selected for processing.

For example, when any icon in the interface 650 is selected, the device may be configured to process a number of digital content items associated with that particular icon. However, the choice in which particular item to process from that subset of items may be made based on a particular algorithm that takes into account a frequency value associated with each item. For example, some items may be assigned a frequency value that indicates the items should be processed, on average, once an hour, whereas some other items may be assigned a frequency value that indicates the items should be processed, on average, once a day. The items with the higher frequency values will then be selected for processing more frequently that the items with a lower frequency value, even though all items may be associated with the same icon in the interface 650. When a particular song is playing, a user may indicate his preference to increase the frequency value for that particular song using the “Short Plus” icon 611 or decrease the frequency value for that particular song using the “Short Minus” icon 616. Unlike the “Long Plus” icon 610 and the “Long Minus” icon 615, the “Short Plus” icon 611 and the “Short Minus” icon 616 may not affect which songs are associated with the “Top . . . ” icons but may affect how often a song is played after the user selects an icon associated with that particular song.

It will be appreciated that, in some embodiments, the functionality of the “Long Plus” icon 610 and the “Short. Plus” icon 611 as well as the functionality of the “Long Minus” icon 615 and the “Short Minus” icon 616 may be implemented in the same icons using, for example, a length of a touch to distinguish between the “Long” version of the functionality and the “Short” version of the functionality. In other words, a user may touch the “Plus” icon 610 or the “Minus” icon 615 quickly to select a “Short” functionality or may touch the “Plus” icon 610 or the “Minus” icon 615 longer to select a “Long” functionality. Alternatively, the “Long” or “Short” functionality/distinction may be made based on the difference between a single click or a double click of the “Plus” icon 610 or the “Minus” icon 615.

In another embodiment, when the user indicates their preference for a particular item of content using the “Short Plus” icon 611, the interface 600 may change the appearance of the “Short Plus” icon 611 to indicate that the user can make a donation to the content owner (e.g., artist, studio, etc.) associated with the item that the user has indicated they like. For example, the appearance of the “Short Plus” icon 611 may be changed to show a dollar symbol (“$”) to indicate that the user can make a donation to the artist of a particular song. If the user clicks on the “Short Plus” icon 611 again when the icon displays the “$” symbol, then a donation will be deducted from a user's account and transferred to an account associated with the artist. In such ways, the users may show their appreciation of an artist's music through a monetary donation. It will be appreciated that, instead of changing the appearance of the “Short Plus” icon 611, the interface 650 may simply display another icon that enables the user to make a donation to the artist.

Although the functionality of the control icons described in FIGS. 6A and 6B is described in association with a library of digital audio files associated with music from particular artists, such functionality may also be implemented with other types of digital content such as movies, television programs, streaming channels, and the like.

Although not shown explicitly, a service that implements the interface 200/400/600/650 may implement various algorithms to promote certain content added to the library of digital content. In one embodiment, an algorithm may set a frequency value associated with an item of digital content to an initial value that ensures that the item is processed more frequently than other songs after the item is added to the library. The item may also be added to the default lists of highest ranked content such that the item is processed when the user selects various “Top . . . ” icons associated with that item. For example, a song may be added to a library and be set to be selected for processing once every few hours initially when a user selects an icon associated with that song. The song may also be added to the list of highest ranked items, either at the top of the list, the bottom of the list, or somewhere in the middle of the list, per the desires of the developer. Thus such newly added songs are ensured to be played more frequently as user's listen to songs using the interface.

As time passes since the item was added to the digital library, the ranking or frequency value associated with the item may be adjusted. The ranking and/or frequency value may be adjusted based on one or more user's use of the “Long Plus”, “Long minus”, “Short plus”, and “Short minus” icons. In another embodiment, the ranking and/or frequency value associated with the item may be changed over time automatically. For example, the service may be configured to automatically drop the ranking and/or frequency value for an item at certain times since the item was added to the library of digital content. Consequently, while the item appears to be highly ranked and/or is processed more often than other items initially, the ranking and/or frequency value associated with the item will decrease over time, even without feedback from users of the interface, such that the item will become ranked and/or processed at a frequency equal to the average ranking and/or frequency of items in the digital library. In one embodiment, the service may be configured to adjust the ranking and/or frequency value associated with an item from a highest rating/highest frequency value set when the item is initially added to the library to an average rating/average frequency value at a certain time period after the item was added to the library. In one example, the service may automatically decrease the ranking/frequency value for the item over the period of 1 week, 2 weeks, 1 month, 1 year, or the like.

In another embodiment, a service may control the playlists associated with each of the icons in the interface according to certain rules and two or more icons associated with a subset of the items in the digital library. As used herein, a playlist may comprise a list of items in the library of digital content associated with a particular icon. The playlist may include a link or pointer to individual content items as well as additional metadata associated with that content item. For example, the metadata may include a priority value or a frequency value that specifies an order in the playlist or an expected frequency that the item should be selected for processing, respectively. The service may control how content in the digital library is used to populate the playlists associated with the various icons (e.g., by changing the tags associated with each item of different content).

For example, the interface may include a “New” icon as well as one or more time period icons (e.g., “2010s”, “2000s”, etc.) associated with a particular genre of the content. As items are added to the digital library associated with the interface, these items may be associated with the “New” icon for the corresponding genre. The association may be performed by tagging the content with a “New” keyword. The added items may be referred to as “Newcomer” content items. Each Newcomer content item may be associated with a test period that is a period of time (e.g., 1 week, 1 month, etc.) during which said Newcomer content item is to remain on a high frequency rotation whenever a user selects the “New” icon, independent of any user feedback via, for example, the “Plus” and “Minus” icons. The test period may be measured from the time the Newcomer content item was added to the digital library to the current time.

It will be appreciated that other content items may have been previously added to the digital library and that a subset of such items may be associated with the “New” icon at the time a Newcomer content item is added to the digital library. All items that are associated with the “New” icon and that are not within a corresponding test period associated with that item may be divided into distinct rotation groups based on user feedback. For example, a first “Hot” rotation group may comprise a set of items that a majority of users like. A second “Regular” rotation group may comprise a set of items that some users like and other users dislike. A third “Cooled” rotation group may comprise a set of items that most users dislike. When a user selects the “New” icon, items in the “Hot” rotation group may be processed more frequently than items in the “Regular” rotation group, which may be processed more frequently than items in the “Cooled” rotation group. All Newcomer content items may be included in the “Hot” rotation group while the test period has not expired.

The number of items that may be associated with the “New” icon may be limited such that, if n items are associated with the “New” icon and another item is added to the digital library, at least one item may be disassociated from the “New” icon. Typically, the item that is disassociated from the “New” icon is selected as the item for which the test period has expired and currently has the most negative feedback from users. When such items are disassociated from the “New” icon, such items may also be removed from the digital library permanently or semi-permanently.

The “New” icon may also be associated with a term period that that refers to a duration of time during which the Newcomer content items are to remain in rotation and receive viewer feedback via the interface. While a Newcomer content item is still within the term period (i.e., the time that a Newcomer content item has been in rotation and associated with the “New” icon is less than the term period), the Newcomer content item may be moved between rotation groups or disassociated from the “New” icon and removed from the digital library. After the term period has expired for a particular Newcomer content item, and such Newcomer content item has not been disassociated from the “New” icon based on negative feedback, the Newcomer content item may be disassociated from the “New” icon and associated with another icon, such as a time period icon corresponding to a particular genre associated with the Newcomer content item (e.g., “2010s Country” icon, etc.). The term period may be, for example, 3 months. If the item has remained in the subset of items in rotation for the “New” icon during the entire term period and has not been disassociated due to being the least favorite item of the users when a different item was added to the digital library, then the item is permanently included in the digital library and associated with the other icons in the interface (e.g., “2010s . . . ”, “Top . . . ”, etc.).

As described above, new items will be added to the digital library and promoted for a test period during which the items are in high rotation independent of user feedback. Once the test period expires, the items will remain in high rotation or be moved into one of the other rotation groups based on user feedback provided via the interface. As other items are added to the digital library, the items associated with the most negative feedback that haven't reached the term period may be removed from the digital library permanently. However, if the user feedback is sufficient to keep the item in at least one of the rotation groups associated with the “New” icon for a period of time equal to the term period, then such items are added to the digital library permanently or semi-permanently and associated with the other icons in the interface.

Once an item is added to the digital library, the item may be associated with one or more other icons in the interface. Each of the other icons, such as, e.g., a “2010s . . . ” icon, may also divide the group of items associated with that icon into one or more rotation groups similar to the rotation groups of the “New” icons described above. However, one rotation group may be associated with one or more items that are not processed even though such items are associated with the icon. Such a rotation group may be referred to as, e.g., a “Frozen.” rotation group. For example, a particular icon may be limited to a playlist of 100 songs, but 150 songs may be included in the digital library and associated with that icon. Thus, 50 songs associated with that icon may be included in the “Frozen” rotation group and not processed even if the user selects that icon. Such items may be included in the “Frozen” rotation group based on user feedback.

Periodically, items that have been included in the “Frozen” rotation group the longest may be reintroduced into one of the other rotation groups for a period of time where users may provide additional feedback. For example, every day or every week one or more items may be moved from the “Frozen” rotation group up into the “Hot” rotation group forcing one or more corresponding items in the “Cooled” rotation group to be moved into the “Frozen” rotation group, at least temporarily. Thus, each of the items moved into the “Frozen” rotation, group due to negative user feedback is given the chance to be processed and to accumulate additional positive feedback from user's preferences that may have changed over time due to changing demographics of the customers using the interface or simply changing tastes of the same customers that provided the previous negative feedback.

It will be appreciated that the algorithms selected for promoting new items being added to the library may take many forms and that the exemplary algorithms described above are for illustrated purposes only. Other algorithms may be implemented for promoting and/or adding new content to the library of digital content.

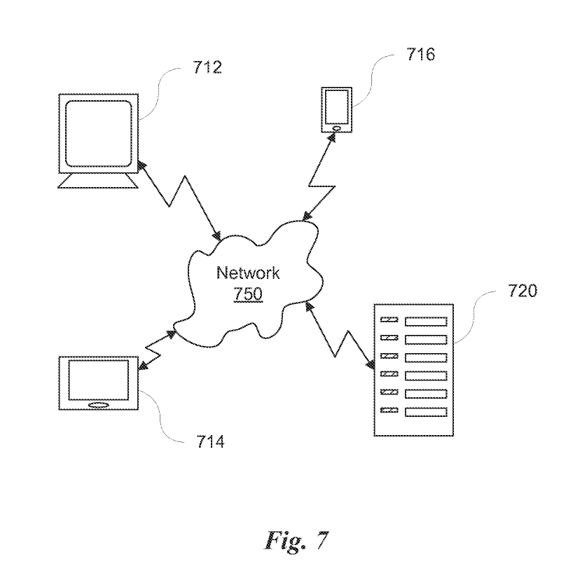

FIG. 7 illustrates a network environment having a plurality of devices, in accordance with one embodiment. As shown in FIG. 7, a plurality of devices are attached to the network 750, including a desktop computer 712, a tablet 714, a mobile device 716, and a server 720. The network 750 may comprise a local area network (LAN), a wireless local area network (WLAN), a wide area network (WAN), or any other type of network such as a cellular network. In one embodiment, the network 750 represents the Internet, or a collection of devices connected via an Internet Protocol (IP) and one or more physical/data link layers such as Ethernet (i.e., IEEE 802.3) or WiFi (i.e., IEEE 802.11). Each device may be connected to the network via a communications link such as via a network interface controller (NIc), a radio transceiver, a Fiber optic cable, and the like.

In one embodiment, the server 720 is configured to enable access to one or more streaming multimedia channels to each of the devices connected to the network 750. Each device may include an application; either a stand-alone application or a web-based application viewed using a client web browser such as Google Chrome, Apple Safari, or the like. The application may implement the interface 200 to enable the user to process digital content via the device.

In one embodiment, the application may send a request to a server 720 to retrieve content to include in the interface 200. For example, the application may send an HTTP request to the server to retrieve markup language data for a particular web page. The markup language data (e.g., HTML, XML, etc.) may include instructions for generating and displaying the interface on a web browser client hosted on the device. The markup language data may also include the content used to populate the icons (e.g., text, thumbnails, low resolution videos, etc.). Each icon may also be associated with a command that is transmitted to the server 720 when the user selects that icon, the command configured to indicate which icon was selected to an application hosted by the server. The application associates each icon in the interface 200 with one or more sets of tags and may be configured to query a database to return a set of digital content associated with that icon. The server 720 may select a particular digital content associated with that icon to be processed by the device and send an HTML response to the device that specifies the particular digital content to be processed. The HTML response may include the data of the digital content or may include a reference (i.e., pointer, URL, etc.) that indicates a location that the device can retrieve the digital content for processing. The device may then process the digital content such as by playing audio via the speakers or presenting images and/or video on a display of the device.

Again, as the digital content is processed, the application may update the graphical representation of the icons in the interface 200 based on data transmitted by the server 720. For example, the data may include a thumbnail image associated with the current audio or video file being streamed over a streaming channel included in the library. The application may then render the icon for that streaming channel using the thumbnail image, such as by overlaying an action symbol on top of the thumbnail image in order to present the icon on a particular portion of the screen. It will be appreciated that the data transmitted by the server 720 for rendering the icon is not limited to image data and may include text, image data, video data, three-dimensional graphics data, metadata, or a command that causes the application to perform some additional action in order to render the content icon (e.g., by requesting additional data from a third party source such as a website, etc.).

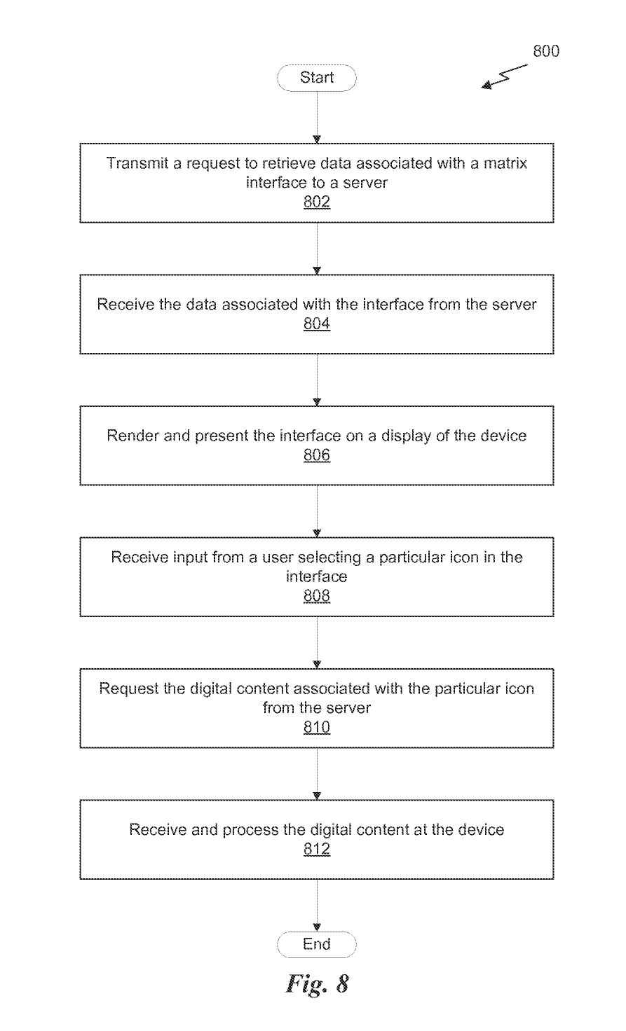

FIG. 8 illustrates a flowchart of a method 800 for displaying a matrix interface on a device, in accordance with another embodiment. Although the method is described in the context of a program executed by a processor, the method may also be performed by custom circuitry or by a combination of custom circuitry and a program. At step 802, a device transmits a request to retrieve data associated with a matrix interface 200 to a server. The request may be initiated when a user opens an application or directs a browser to an URL associated with a webpage that includes the interface 200. At step 804, the device receives the data associated with the interface 200 from a server. In one embodiment, the data may include thumbnail images associated with a plurality of streaming multimedia channels such that an application may render the interface 200 using the thumbnail images. In another embodiment, the data may include the entire interface embodied within, e.g., html or xml content to be rendered by a web browser. The html or xml content may include a reference to the thumbnail images to be used in displaying the interface 200.

At step 806, the device renders the interface 200 and presents the interface on a display of the device. At step 808, the device receives input from a user selecting a particular icon in the interface 200. At step 810, the device requests the digital content associated with the particular icon from the server. At step 812, the device receives the digital content from the server and processes the digital content. In one embodiment, the device may process the digital content by playing the digital content on the device such as by presenting image or video data on the display and/or outputting the digital content to speakers associated with the device.

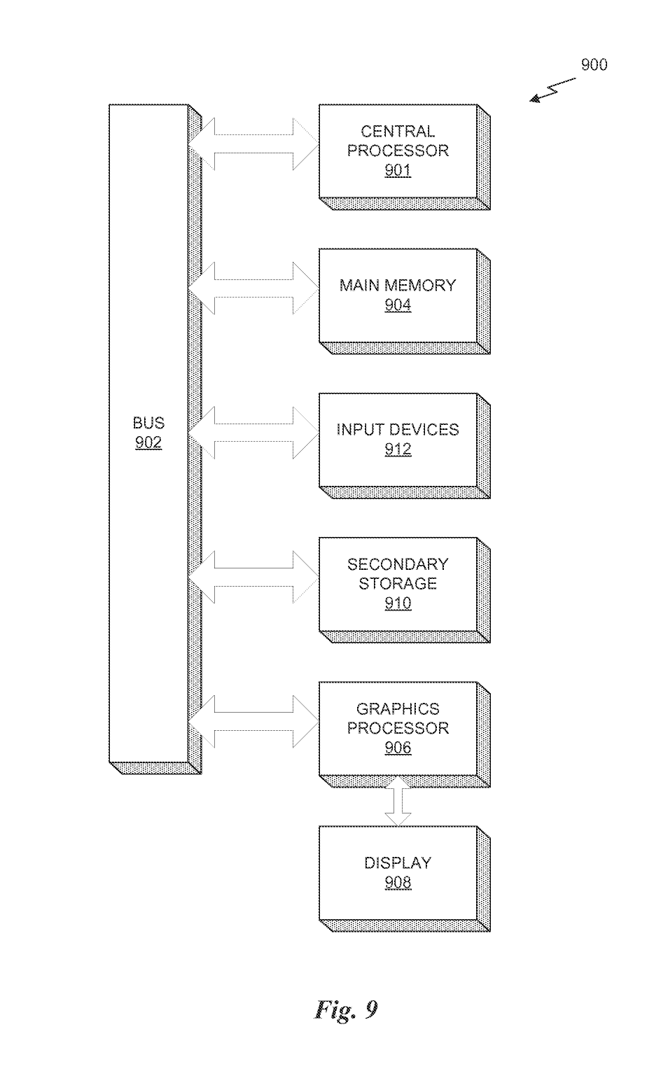

FIG. 9 illustrates an exemplary system 900 in which the various architecture and/or functionality of the various previous embodiments may be implemented. The system 900 may comprise a device configured to implement the interface 200. As shown, a system 900 is provided including at least one central processor 901 that is connected to a communication bus 902. The communication bus 902 may be implemented using any suitable protocol, such as PCI (Peripheral Component Interconnect), PCI-Express, AGP (Accelerated Graphics Port), HyperTransport, or any other bus or point-to-point communication protocol(s). The system 900 also includes a main memory 904. Control logic (software) and data are stored in the main memory 904 which may take the form of random access memory (RAM).

The system 900 also includes input devices 912, a graphics processor 906, and a display 908, i.e. a conventional CRT (cathode ray tube), LCD (liquid crystal display), LED (light emitting diode), plasma display or the like. User input may be received from the input devices 912, e.g., keyboard, mouse, touchpad, microphone, and the like. In one embodiment, the graphics processor 906 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 900 may also include a secondary storage 910. The secondary storage 910 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 904 and/or the secondary storage 910. Such computer programs, when executed, enable the system 900 to perform various functions. The memory 904, the storage 910, and/or any other storage are possible examples of computer-readable media.

In one embodiment, the architecture and/or functionality of the various previous figures may be implemented in the context of the central processor 901, the graphics processor 906, an integrated circuit (not shown) that is capable of at least a portion of the capabilities of both the central processor 901 and the graphics processor 906, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 900 may take the form of a desktop computer, laptop computer, server, workstation, game consoles, embedded system, and/or any other type of logic. Still yet, the system 900 may take the form of various other devices including, but not limited to a personal digital assistant (PDA) device, a mobile phone device, a television, etc.

Further, while not shown, the system 900 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method comprising:
receiving instructions, from a server computer via a network interface, for generating a graphical user interface (GUI) that includes a matrix interface that enables a user to select one or more items of digital content from a library of digital content to be processed by a device, wherein the library of digital content is represented by a database that associates one or more tags with each item of digital content; and
executing the instructions to cause the matrix interface to be presented on a web browser client hosted on the device,
wherein the matrix interface comprises a plurality of icons arranged in a two-dimensional array including at least two rows of icons and at least two columns of icons, each icon in the plurality of icons is associated with a portion of the digital content, and
wherein each icon in the plurality of icons is associated with one or more sets of tags that, when included in a query of the database, returns the portion of the digital content in the library of digital content corresponding to that icon.

2.-3. (canceled)

4. The method of claim 1, wherein:
a particular row of icons corresponds to a first set of tags that describe the digital content,
a particular column of icons corresponds to a second set of tags that describe the digital content, and
a particular icon in the matrix interface included in both the particular row of icons and the particular column of icons is configured to select zero or more items of digital content returned by a query to the database based on the first set of tags and the second set of tags.

5. The method of claim 4, wherein each tag comprises one or more keywords that describe the items included in the library of digital content.

6. The method of claim 1, wherein the matrix interface is configured to be displayed on two or more devices that implement different operating system environments, and wherein a subset of icons in the plurality of icons are selected to be initially presented on the display based on a native resolution of the display associated with the device.

7. The method of claim 6, wherein additional icons associated with the matrix interface that are not included in the subset of icons may be displayed in response to user input.

8. The method of claim 1, wherein a graphical representation of at least one icon in the plurality of icons comprises an action symbol overlaid over a thumbnail image.

9. The method of claim 8, wherein the action symbol comprises a graphical representation selected from the group consisting of a play symbol, a pause symbol, a stop symbol, a skip symbol, and a mute symbol.

10. The method of claim 8, wherein the action symbol is rendered as partially transparent.

11. The method of claim 1, wherein the digital content comprises data of a format selected from the group consisting of a digital video format, a digital audio format, and a digital image format.

12. The method of claim 1, wherein a first portion of the matrix interface is presented on a display of a first device having a first native resolution and a second portion of the matrix interface is presented on a display of a second device having a second native resolution that is different from the first native resolution, the first portion being at least partially different from the second portion.

13. A system comprising:
a device associated with a display, the device configured to:
receive instructions, from a server computer via a network interface, for generating a graphical user interface (GUI) that includes a matrix interface that enables a user to select one or more items of digital content from a library of digital content to be processed by a device, wherein the library of digital content is represented by a database that associates one or more tags with each item of digital content; and
execute the instructions to cause the matrix interface to be presented on a web browser client hosted on the device;
wherein the matrix interface comprises a plurality of icons arranged in a two-dimensional array including at least two rows of icons and at least two columns of icons, each icon in the plurality of icons is associated with a portion of the digital content; and
wherein each icon in the plurality of icons is associated with one or more sets of tags that, when included in a query of the database, returns the portion of the digital content in the library of digital content corresponding to that icon.

14. (canceled)

15. The system of claim 13, wherein the matrix interface is configured to be displayed on two or more devices that implement different operating system environments, and wherein a subset of icons in the plurality of icons are selected to be initially presented on the display based on a native resolution of the display associated with the device.

16. The system of claim 13, wherein the server computer is configured to update at least a portion of the matrix interface in response to a request from the device, and wherein the server computer is configured to transmit at least one item of digital content to the device in response to the user selecting a particular icon in the matrix interface.

17. (canceled)

18. The system of claim 13, wherein:
a particular row of icons corresponds to a first set of tags that describe the digital content,
a particular column of icons corresponds to a second set of tags that describe the digital content, and
a particular icon in the matrix interface included in both the particular row of icons and the particular column of icons is configured to select zero or more items of digital content returned by a query to the database based on the first set of tags and the second set of tags.

19. A non-transitory computer-readable storage medium storing instructions that, when executed by a processor, cause the processor to perform steps comprising:
receiving instructions, from a server computer via a network interface, for generating a graphical user interface (GUI) that includes a matrix interface that enables a user to select one or more items of digital content from a library of digital content to be processed by a device, wherein the library of digital content is represented by a database that associates one or more tags with each item of digital content; and
executing the instructions to cause the matrix interface to be presented on a web browser client hosted on the device,
wherein the matrix interface comprises a plurality of icons arranged in a two-dimensional array including at least two rows of icons and at least two columns of icons, each icon in the plurality of icons is associated with a portion of the digital content, and
wherein each icon in the plurality of icons is associated with one or more sets of tags that, when included in a query of the database, returns the portion of the digital content in the library of digital content corresponding to that icon.

20. A non-transitory computer-readable storage medium storing instructions that, when executed by a processor, cause the processor to perform steps comprising:
receiving a request from a device, via a network, for data associated with a graphical user interface (GUI) that includes a matrix interface that enables a user to select one or more items of digital content from a library of digital content to be processed by a device, wherein the library of digital content is represented by a database that associates one or more tags with each item of digital content; and
in response to the request, transmitting the data to the device, wherein the device is configured to present the matrix interface on a web browser client hosted on the device,
wherein the matrix interface comprises a plurality of icons arranged in a two-dimensional array including at least two rows of icons and at least two columns of icons, each icon in the plurality of icons is associated with a portion of the digital content, and
wherein each icon in the plurality of icons is associated with one or more sets of tags that, when included in a query of the database, returns the portion of the digital content in the library of digital content corresponding to that icon.
